(19) United States
(12) Patent Application Publication
(10) Pub. No.: US 2023/0041806 A1
(43) Pub. Date: Feb. 9, 2023

(54) LOCATION-INDEPENDENT PROGRAMMING DATA PLANE FOR PACKET PROCESSING

(71) Applicant: Oracle International Corporation, Redwood Shores, CA (US)

(72) Inventor: Brijesh Singh, Mercer Island, WA (US)

(73) Assignee: Oracle International Corporation, Redwood Shores, CA (US)

(21) Appl. No.: 17/394,300

(22) Filed: Aug. 4, 2021

(51) Int. Cl. H04L 12/24

(52) U.S. Cl. CPC H04L 41/0803

(57) ABSTRACT

Techniques are disclosed for efficient communications over a network path between an accelerator of a smart network interface card (smartNIC) and a remote programming data plane of a remote device. In one example, the accelerator receives an instruction to register a pairing between the accelerator and the remote programming data plane, and then stores registration data indicating the pairing. The accelerator then receives from the remote programming data plane a second instruction associated with processing one or more flows. The accelerator then stores instruction data corresponding to the second instruction based on confirming the registered pairing with the remote programming data plane. Subsequently, the accelerator receives a data packet and processes the data packet in accordance with the stored instruction data. In some embodiments, the accelerator may transmit packets to the pair remote programming data plane, for example, requesting further instructions associated with processing a packet.

### CROSS-REFERENCE TO RELATED APPLICATIONS

This application is related to U.S. Non-Provisional application Ser. No. 17/244,723, entitled, “Port Addressing Via Packet Header Modification (088325-1213711-284200US),” filed Apr. 29, 2021. This application is also related to U.S. Non-Provisional application Ser. No. 17/244,727, entitled, “Efficient Flow Management Utilizing Control Packets (088325-1212054-283500US),” filed Apr. 29, 2021. The full disclosures of which are incorporated by reference herein in their entirety for all purposes. This application is also related to U.S. Non-Provisional application Ser. No. 17/389,219, entitled “Efficient Flow Management Utilizing Unified Logging (088325-1212052-283400US),” filed Jul. 29, 2021.

### BACKGROUND

Cloud services computing systems are often tasked with, among other computing operations, processing packets. For example, packet processing operations may include routing and/or forwarding packets, implementing security list functionality to only forward certain packets, determining rules for subsequent processing of packets for a particular flow, etc. As the amount of network traffic has grown substantially in recent years, modern cloud computing systems often need to process a large number of packets per second. To help process packets efficiently, techniques and/or devices have been utilized to offload some of the processing burden from a server processor (e.g., a central processor unit (CPU)).

For example, some network devices (e.g., smart network interface cards (smartNICs)) may include specialized hardware that is dedicated to performing packet processing, thus helping to relieve the server CPU of at least some packet processing computing tasks. In one example, a smartNIC may include a data plane that includes hardware for accelerating the routing and/or forwarding of packets for known traffic flows. Some smartNICs may also include a programming data plane. While the programming data plane may also be enabled to process packets (e.g., similar to the accelerator), the programming data plane may additionally be configured to offload more complex processing tasks from the accelerator, so that the accelerator may be even more optimized to perform packet forwarding. For example, some of these more complex tasks may include programming the data plane with new instructions, determining instructions for handling new flows, analyzing packets to a generate flow statistics report, etc. While separating the data plane and the programming data plane of a smartNIC has enabled packet processing efficiency gains, challenges remain. For example, a programming data plane that is a physical component of the smartNIC may have limited visibility into an external environment (e.g., a virtual cloud), and thus may be restricted in terms of the types of processing tasks that it may offload from the accelerator. Also, including the programming data plane within the smartNIC may increase the manufacturing costs and/or the complexity of the smartNIC.

### BRIEF SUMMARY

Techniques are provided for enabling a remote (e.g., location-independent) programming data plane of a remote device to pair with a data plane of a network virtualization device (NVD). The techniques further enable the remote programming data plane to efficiently coordinate management of network traffic flows by the NVD.

In an embodiment, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method. The method also includes receiving, by an accelerator of a smart network interface card (smartNIC), a first instruction, the first instruction instructing the accelerator to register a pairing between the accelerator and a remote programming data plane of a device that is physically distinct from the smart network interface card and is communicatively connected to the smart network interface card via a network path. The method also includes storing, by the accelerator, registration data indicating the pairing between the accelerator and the remote programming data plane of the device. The method also includes receiving, by the accelerator from the remote programming data plane, a second instruction over the network path, the second instruction associated with processing one or more flows. The method also includes processing, by the accelerator, instruction data corresponding to the second instruction based at least in part on determining that the second instruction was received from the remote programming data plane of the device over the network path. Other embodiments of this aspect include corresponding computer systems, apparatus, and computer programs recorded on one or more computer storage devices, each configured to perform the actions of the methods.

One general aspect includes a smart network interface card (smartNIC). The smart network interface card also includes an accelerator may include a set of one or more processors of a plurality of processors. The card also includes a memory may include computer-executable instructions that, when executed by one or more of the plurality of processors, cause the smart network interface card to: receive, by an accelerator of a smart network interface card (smartNIC), a first instruction, the first instruction instructing the accelerator to register a pairing between the accelerator and a remote programming data plane of a device that is physically distinct from the smart network interface card and is communicatively connected to the smart network interface card via a network path; store, by the accelerator, registration data indicating the pairing between the accelerator and the remote programming data plane of the device; receive, by the accelerator from the remote programming data plane, a second instruction over the network path, the second instruction associated with processing one or more flows; and process, by the accelerator, instruction data corresponding to the second instruction based at least in part on determining that the second instruction was received from the remote programming data plane of the device over the network path. Other embodiments of this aspect include corresponding computer systems, apparatus, and computer programs recorded on one or more computer storage devices, each configured to perform the actions of the methods.

One general aspect includes one or more non-transitory computer-readable storage media may include computer-executable instructions that. The one or more non-transitory computer-readable storage media also includes receive, by an accelerator of a smart network interface card (smartNIC), a first instruction, the first instruction instructing the accelerator to register a pairing between the accelerator and a remote programming data plane of a device that is physically distinct from the smart network interface card and is communicatively connected to the smart network interface card via a network path. The media also includes store, by the accelerator, registration data indicating the pairing between the accelerator and the remote programming data plane of the device. The media also includes receive, by the accelerator from the remote programming data plane, a second instruction over the network path, the second instruction associated with processing one or more flows. The media also includes process, by the accelerator, instruction data corresponding to the second instruction based at least in part on determining that the second instruction was received from the remote programming data plane of the device over the network path. Other embodiments of this aspect include corresponding computer systems, apparatus, and computer programs recorded on one or more computer storage devices, each configured to perform the actions of the methods.

### BRIEF DESCRIPTION OF DRAWINGS

FIG. 1 is a simplified block diagram illustrating an example environment for enabling a remote programming data plane of a device to efficiently coordinate processing of network traffic by a network virtualization device (NVD), according to some embodiments.

FIG. 2 is a simplified block diagram illustrating an example architecture of an NVD and a remote programming data plane of another device, according to some embodiments.

FIG. 3 is a simplified block diagram illustrating an example technique for managing a flow by an NVD, according to some embodiments.

FIG. 4 is another simplified block diagram illustrating an example format for a control packet, according to some embodiments.

FIG. 5 is a simplified flow diagram illustrating an example technique for pairing an accelerator of an NVD with a remote programming data plane of another device, according to some embodiments.

FIG. 6 is another simplified flow diagram illustrating an example process for efficiently coordinating management of flows between an accelerator of an NVD and a remote programming data plane of another device, according to some embodiments.

FIG. 7 is another simplified flow diagram illustrating an example process for pairing an accelerator of an NVD with a remote programming data plane of another device, according to some embodiments.

FIG. 8 is another simplified flow diagram illustrating an example process for efficiently coordinating management of flows between an accelerator of an NVD and a remote programming data plane of another device, according to some embodiments.

FIG. 9 is another simplified flow diagram illustrating an example process for efficiently coordinating management of flows between an accelerator of an NVD and a remote programming data plane of another device, according to some embodiments.

FIG. 10 is a high level diagram of a distributed environment showing a virtual or overlay cloud network hosted by a cloud service provider infrastructure according to certain embodiments.

FIG. 11 depicts a simplified architectural diagram of the physical components in the physical network within a cloud service provider infrastructure (CSPI) according to certain embodiments.

FIG. 12 shows an example arrangement within CSPI where a host machine is connected to multiple network virtualization devices (NVDs) according to certain embodiments.

FIG. 13 depicts connectivity between a host machine and an NVD for providing I/O virtualization for supporting multitenancy according to certain embodiments.

FIG. 14 depicts a simplified block diagram of a physical network provided by a CSPI according to certain embodiments.

FIG. 15 is a block diagram illustrating one pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating another pattern for implementing a cloud infrastructure as a service system, according to at least one embodiment.

FIG. 19 is a block diagram illustrating an example computer system, according to at least one embodiment

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure provide techniques for coordinating management of flows between an accelerator of an NVD and a remote programming data plane of another device. Consider an example in which the NVD corresponds to a smartNIC device, and the smartNIC is communicatively connected to a first (e.g., remote) host device via a network path (e.g., a virtual network). The smartNIC device may include at least a data plane (which may be referred to herein as an “accelerator”), and the remote host device may execute a remote programming data plane (e.g., implemented as a service). The accelerator of the smartNIC may include software and/or hardware that is collectively enabled (e.g., optimized) to perform tasks associated with packet routing and/or packet forwarding at high processing rates (e.g., 50, 100, or 200 Gigabits (Gb)/s). Meanwhile, the remote programming data plane, when paired with the accelerator, may be enabled to perform tasks associated with coordinating packet routing and/or packet forwarding by the smartNIC device.

For example, the paired remote programming data plane may receive from the accelerator a data packet (e.g., for a new flow) via the network path, in which the remote programming data plane may determine how to process the data packet. The remote programming data plane may also be enabled to control the accelerator (e.g., to which it is paired) by causing the accelerator to program instructions associated with processing packets that are subsequently received and processed by the accelerator. By enabling pairing (and subsequent coordination) between an NVD and a remote programming data plane (e.g., of a remote device), techniques described herein may improve NVD resiliency and/or reduce NVD manufacturing costs, in part by enabling offloading of local programming data plane features of an NVD to the remote device (e.g., which may be fungible with other remote devices). In some embodiments, techniques may further enable the remote programming data plane to provide enhanced functionality (e.g., relative to a programming data plane that is local to an NVD), in part because the remote programming data plane may have increased contextual visibility of the surrounding environment (e.g., having greater access to contextual data associated with customer profiles, network conditions, network traffic policies, etc.).

In an illustrative example, consider a scenario in which a cloud services provider provides a cloud computing service (e.g., infrastructure as a service (IaaS)) that enables customers to, among other things, transmit and/or receive data over a network. The cloud computing service may include one or more host machines, memory resources, and network resources that form a physical network. In this example, a virtual network may be created on top of the physical network by utilizing one or more software virtualization technologies (e.g., including one or more network virtualization devices (NVDs), such as a smartNIC, a top-of-rack (TOR) switch, etc.) to create layers of network abstraction that can be run on top of the physical network. The cloud computing service may be responsible for processing a large amount of network traffic, some of which may be transmitted over the virtual network and may require additional processing steps to handle the traffic. For example, customer traffic may be encapsulated and/or decapsulated to facilitate routing in the virtual network. Accordingly, to facilitate more efficient processing (e.g., streamlining) of the large amount of network traffic, the cloud services provider may determine to offload some tasks of the packet processing pipeline from one or more devices to another one or more other devices. In this example, the cloud services provider may determine that a first host machine (e.g., CPU) may process more complex functions such as processing Hypertext Transfer Protocol (HTTP) requests for serving web pages, etc. In the meantime, other tasks may be performed by a smartNIC type of NVD. The smartNIC may correspond to any suitable device (e.g., including hardware and/or software) that may be used to accelerate functionality and offload processing from the first host machine (or storage) CPU. Some non-limiting examples of such tasks performed by the smartNIC may include handling encapsulation/decapsulation of packets, handling encryption/decryption of packets, performing packet routing/forwarding functions, etc. It should be understood that any suitable tasks may be performed by the first host machine and/or otherwise offloaded to the smartNIC NVD.

In this example, the cloud services provider may determine to further streamline the processing of packet data. For example, as described in an earlier example, the smartNIC may include at least a data plane (e.g., an accelerator). As described further herein, one or more processors of the data plane may be tasked with efficiently processing (e.g., routing and/or forwarding) packets. In some embodiments, for example, in the case of processing packets within a virtual network environment, the data plane may also be responsible for encapsulation and decapsulation of packets to facilitate forwarding or routing in the virtual network. The data plane may maintain a cache that stores, among other things, state information associated with one or more flows (e.g., timeout data, statistical data about the flow, routing information, etc.). The data plane may utilize the cache to determine how to process incoming packets.

Meanwhile, at least a portion of functions associated with packet processing by the smartNIC may be further offloaded to a remote programming data plane that is connected to the smartNIC via a network path (e.g., a virtual network). For example, a second host device that is remote (e.g., physically distinct) from the smartNIC may implement, within a remote programming data plane, control functions associated with packet processing by the smartNIC. Some example control functions may include, but are not limited to, determining if a packet and/or flow should be allowed or rejected (e.g., via a security list), determining when an allowed flow should be expired, determining and/or reporting flow statistics, determining instructions for programming the data plane, etc. In some embodiments, the second (e.g., remote) host device may be different from (or the same as) the first host device (e.g., the web server, as described above). For example, as described further herein, the second host device may be one of a plurality of fungible host devices. In this example, each host device may, respectively, implement a remote programming data plane. In some embodiments, a remote programming data plane may be implemented by software and/or hardware resources that collectively execute a service on the respective remote host device. When a remote programming data plane of a particular remote host device is paired with the accelerator of the smartNIC, the remote programming data plane may be authorized to perform control functions associated with packet processing by the smartNIC. In this way, different host devices may interchangeably serve as a remote programming data plane for the smartNIC.

Continuing with the illustration, suppose that the smartNIC receives a first message (e.g., from a third-party entity, such as a network administrator device) that instructs the accelerator of the smartNIC to register a pairing with the remote programming data plane of the second host device. The accelerator may validate the message and store registration data indicating the pairing with the remote programming data plane. Subsequently, the accelerator may receive a second message (e.g., one or more control packets) from the remote programming data plane of the second host device via the network path, whereby the second message includes instructions for processing packets associated with one or more flows. In some embodiments, the remote programming data plane may generate the second message based in part on analyzing data (e.g., a control packet and/or a data packet) received from the accelerator of the smartNIC via the network path. In any case, the accelerator may validate the second message based in part on determining that the accelerator is currently paired with the remote programming data plane. The accelerator may then store (e.g., program into local memory of the smartNIC) instruction data corresponding to the instructions of the second message. In this example, the instruction data may include instructions to add a particular user device (e.g., and/or Internet Protocol (IP) address, client application, etc.) to an “allowed entities” section of a security list. As described further herein, it should be understood that the remote programming data plane may program (and/or otherwise instruct) the accelerator according to any suitable instructions.

The accelerator may subsequently receive a third message (e.g., a data packet) from the particular user device, for example, requesting a webpage to be served from the first host device (e.g., the web server) to the user device. The accelerator may then analyze the data packet and determine how to process the data packet (e.g., forwarding the packet to the web server) based in part on the previously stored instruction data. For example, the accelerator may determine to forward the packet to the web server based in part on the user device being an allowed device of the security list.

In some embodiments, information may be communicated between the accelerator and a remote programming data plane via any suitable mechanism. For example, in one embodiment, the accelerator may transmit a request for instructions to a paired remote programming data plane via a single control packet (e.g., transmitted via the network path), which may be identified via a control packet header. In this embodiment, the control packet payload may fit within a jumbo size frame and may contain data corresponding to the request. Similarly, the remote programming data plane may transmit instructions for programming the accelerator via a single control packet. In some embodiments, a single control packet may also and/or alternatively be used to pair an accelerator with a particular remote programming data plane. For example, the accelerator may receive a single control packet from a suitable entity that includes pairing instructions. In some embodiments, enabling requests and/or instructions to be transmitted via a single control packet may facilitate more efficient communication between devices (e.g., without necessitating a connection setup/tear-down phase). In another embodiment, information may be transmitted between the accelerator a remote programming data plane via a stream of packets. For example, a Transport Control Protocol (TCP) connection may first be established between the accelerator and a remote programming data plane, upon which one or more packets may be transmitted over the established connection. In some embodiments, one or more communications (e.g., packets) may be encrypted (e.g., as encrypted packets) using a suitable protocol (e.g., Internet Protocol Security (IPsec)), which may facilitate trusted pairing and/or subsequent communications between devices.

Embodiments of the present disclosure provide several technical advantages over conventional systems. For example, some conventional techniques utilize an NVD (e.g., a smartNIC device) that includes a programming data plane that is local to the smartNIC device. For example, the programming data plane may be connected to an accelerator of the smartNIC device via a data bus (e.g., a network on a chip (NOC)) and/or a memory that is shared between the programming data plane and the accelerator. However, this type of design has several challenges. For example, a smartNIC that is manufactured to include more complex logic (e.g., that may be typically offloaded from the accelerator to the programming data plane) may increase complexity of the smartNIC. This may increase costs for manufacturing and/or maintaining the smartNIC. For example, increased complexity may lead to decreased reliability (e.g., increased down times, in the event that the programming data plane encounters a processing issue). In another example of a design challenge, including the programming data plane locally within the smartNIC may limit the amount and/or types of information that is accessible by the programming data plane. For example, the programming data plane may not be exposed to regular updates of customer profiles, network policy updates, and other contextual information associated with network processing by the smartNIC. Accordingly, instructions determined by the programming data plane for programming the accelerator may not be optimally tuned and/or updated to incorporate the latest contextual updates.

In contrast, techniques described herein provide increased reliability, flexibility, and/or an enhanced feature set based in part on enabling a remote programming data plane to be paired with an accelerator of a smartNIC. For example, as described herein, a plurality of fungible devices may be respectively provisioned to function as a potential remote programming data plane. In some embodiments, the accelerator may be paired to a particular remote programming data plane at a particular time. However, in the event that the pairing is defective (e.g., the particular remote programming data plane is unavailable via the network path), the accelerator may be efficiently repaired to another device (e.g., a backup remote programming data plane) over the network path. In at least this way, techniques may provide more resiliency (e.g., via redundancy) and flexibility than conventional methods. In another example, by offloading the programming data plane functionality (and/or associated hardware/software resources) from a local smartNIC, techniques may decrease manufacturing and/or maintenance costs of a smartNIC. In yet another example, techniques enable programming data plane functionality to be moved to a service (e.g., of a device) that may have more efficient and/or broader access to contextual information. For example, the remote programming data plane service may be co-located with other services that regularly monitor network applications, customer profile updates, virtual cloud network conditions, etc. Accordingly, the remote programming data plane service may efficiently be updated to incorporate contextual changes, and then more optimally program an accelerator to which it is paired.

For clarity of illustration, embodiments described herein may typically refer to an accelerator (e.g., a data plane) of an NVD (e.g., a smartNIC device) that is paired with a remote programming data plane of a separate device, whereby the accelerator and the remote programming data plane may communicate with each other by sending data packets and/or control packets via a network path. However, embodiments should not be construed to be so limited. For example, a smartNIC of the present disclosure may include both an accelerator and a programming data plane that is local to the smartNIC. In some embodiments, for example, in case when a remote programming data plane (and/or an alternate device) are unavailable via a network path, the accelerator may use (e.g., pair with) the local programming data plane as a backup. In some embodiments, the local programming data plane may also and/or alternatively be used for any suitable purpose. For example, a local programming data plane (e.g., with limited functionality) may include instructions for indicating to the data plane which remote programming data plane the data plane should initiate a pairing with. In another example, the local programming data plane may perform some control functions (e.g., maintaining a security list), while a remote programming data plane may perform other control functions. In this example, the data plane may be effectively paired with both the local programming data plane (e.g., for a first set of functions) and the remote programming data plane (for a second set of functions). Accordingly, it should be understood that any suitable one or more programming data planes (e.g., remote and/or local to the NVD), or combinations thereof, may be used to perform techniques described herein.

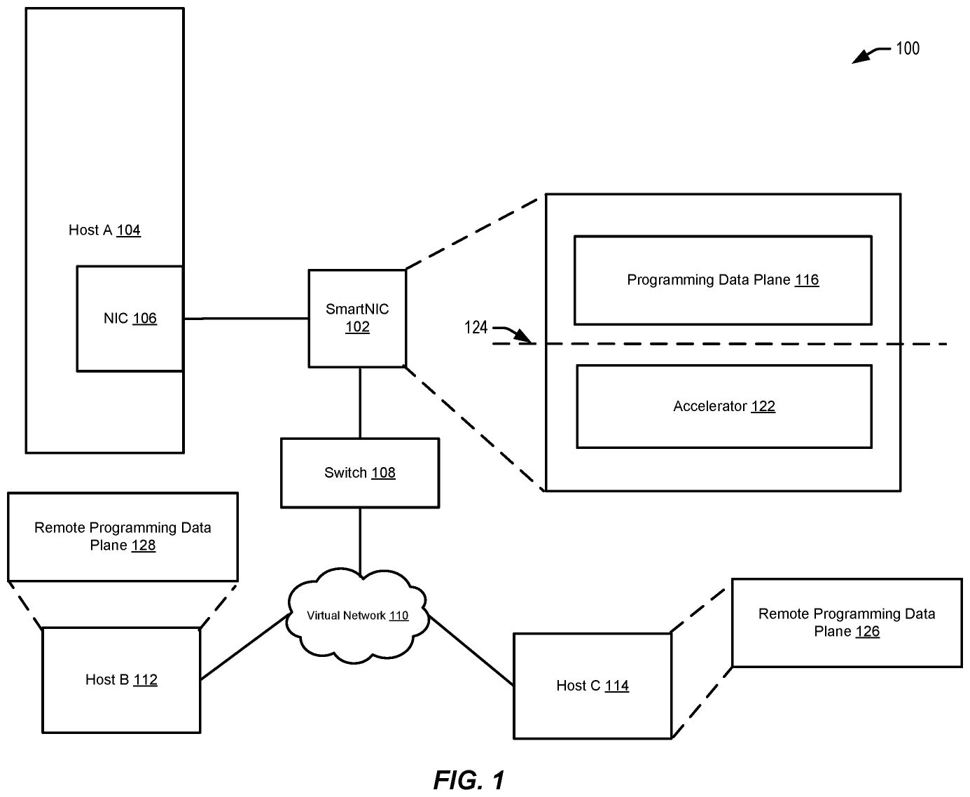

FIG. 1 is a simplified block diagram illustrating an example environment for enabling a remote programming data plane of a device to efficiently coordinate processing of network traffic by a network virtualization device (NVD), according to some embodiments. In the diagram 100 of FIG. 1, a host machine A 104, a smart network interface card (smartNIC) 102, a switch 108, a virtual network 110, a host machine B 112, and a host machine C 114 are depicted. The host machine (or “host”) A 104 includes a network interface card (MC) 106, and is connected to the smartNIC 102, for example, via an Ethernet cable. The smartNIC 102 is connected to the switch 108 (e.g., via an Ethernet cable), and the switch 108 is further connected to host B 112 and host C 114 (e.g., via an Ethernet cable). Although embodiments described herein may typically refer to computing devices being connected via Ethernet cables, it should be understood that any suitable medium (e.g., physical medium, wireless medium) may be used to connect any one or more computing devices.

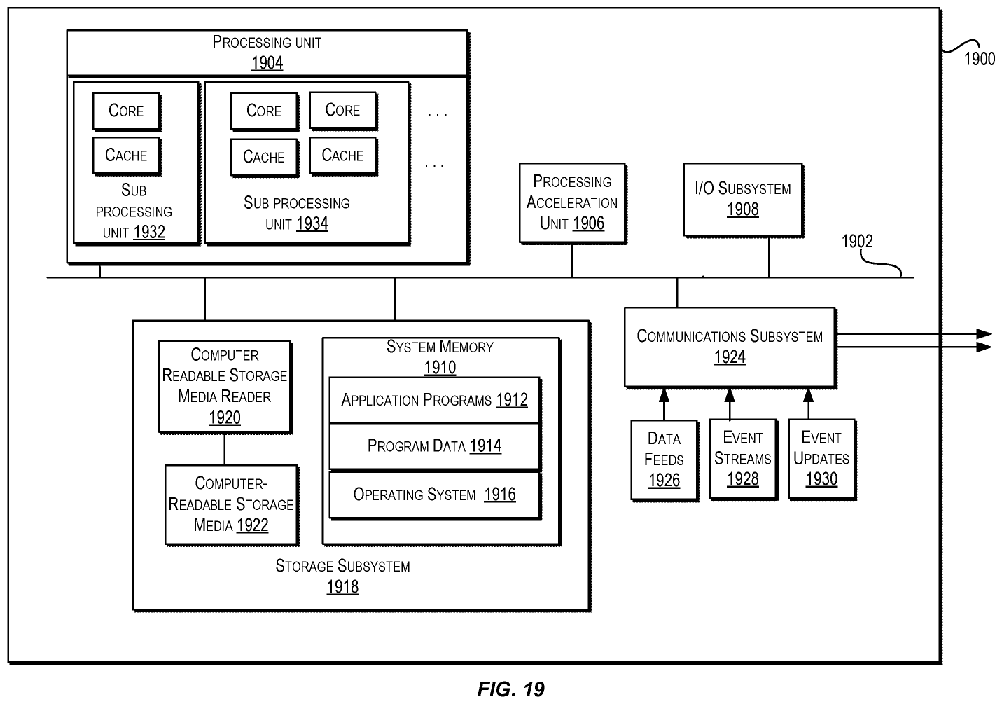

Turning to the elements of FIG. 1 in further detail, the host A 104 may be any suitable computing device that includes the NIC 106. For example, host A 104 (e.g., as a representative example of a host machine) may be a physical computer, similar to as described further herein (e.g., with reference to FIG. 19). The physical computer may include physical resources (e.g., memory, a CPU, the NIC 106, etc.). In some embodiments, as described further herein, the host A 104 may execute a hypervisor, whereby one or more compute instances may be created, executed, and managed on the host A 104 by the hypervisor. In some embodiments, host A 104 may be associated with a cloud services provider (CSP), for example, as part of a CSP infrastructure (CSPI), as described further herein. For example, the host A 104 may be a computing resource in a data center of the CSPI. The host A 104 may communicate with other resources within the CSPI (e.g., the smartNIC 102, switch 108, and/or the virtual network 110) via the NIC 106. The NIC 106 may be any suitable NIC that connects the host A 104 to the computer network (e.g., a physical network and/or a virtual network that is overlaid on the physical network). In the illustration of FIG. 1, the host B 112 and host C 114 may be similar to host A 104, for example, both being connected to the virtual network 110 and in communication with one or more other devices via the virtual network 110. In some embodiments, as described further herein, a host (e.g., host A 104, host B 112, and/or host C 114) may implement one or more features (e.g., via hardware and/or software (e.g., a service)) that collectively function as a remote programming data plane. For example, as depicted in FIG. 1, host B 112 optionally includes remote programming data plane 128, and host C 114 optionally includes remote programming data plane 126. It should be understood that host B 112 and host C 114 are representative computing devices, and that the CSPI may contain any suitable number of physical computing devices and/or compute instances (e.g., within a single physical computing device). Any one or more of these devices may be in communication with other devices over the physical network and/or the virtual network 110 that is overlaid on the physical network, as described further herein.

Turning to the smartNIC 102 in further detail, the smartNIC 102 may correspond to any suitable network virtualization device (NVD) that offloads processing tasks (e.g., network processing tasks) from a computing device (e.g., host A 104). As described further herein, an NVD may correspond to a device that implements a network virtualization technology, including, for example, a smartNIC, a top-of-rack (TOR) switch, a smart TOR switch, etc. As depicted in FIG. 1, in some embodiments, the smartNIC 102 may include, among other elements, an accelerator 122. In some embodiments, the accelerator 122 may be configured to efficiently process (e.g., route and/or forward) packets. As described herein, the accelerator 122 may be programmed with instructions associated with processing packets. In some embodiments, the accelerator 122 may maintain a cache of cache entries, each cache entry associated with a flow. In some embodiments, the accelerator 122 may determine how to process an incoming packet based in part on determining if the packet is associated with an existing approved flow (e.g., determining whether a cache entry for the flow exists). In some embodiments, the accelerator 122 may be further programmed with instructions associated with pairing with a programming data plane. In some embodiments, the pairing may indicate to the accelerator that the programming data plane to which it is paired will handle at least a portion of control functions and/or packet processing functions, as described herein. In some embodiments, the accelerator 122 may be paired with a programming data plane that is local to the smartNIC 102, a remote programming data plane, and/or any suitable combination thereof.

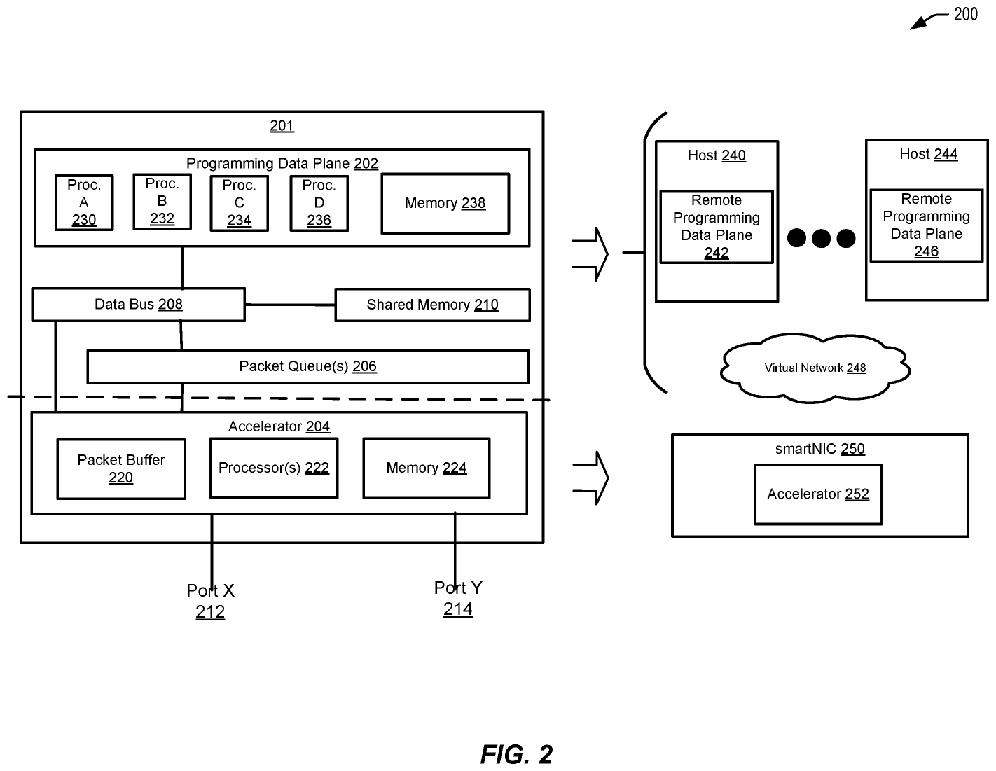

For example, in some embodiments, as depicted in FIG. 1, the smartNIC 102 may optionally include a programming data plane 116 (which may alternatively be referred to herein as a “local programming data plane”). In some embodiments, the programming data plane 116 may not be included within smartNIC 102, as depicted in FIG. 1 by dotted line 124. This may be the case, for example, in which the accelerator 122 is paired with a remote programming data plane, such that programming data plane tasks are offloaded from the smartNIC 102 to another device that implements the remote programming data plane, as described further herein. Turning to a case in which programming data plane 116 is present within smartNIC 102, the programming data plane 116 may be communicatively connected to (e.g., paired with) the accelerator 122 within the smartNIC 102 via one or more components. For example, as described further in reference to FIG. 2, the smartNIC 102 may include a data bus (e.g., enabling data and/or control packets to be communicated between the accelerator 122 and the programming data plane 116), a shared memory (e.g., enabling sharing of information between the two planes (accelerator 122 and local programming data plane 116) of the smartNIC 102), one or more packet queues (e.g., further enabling processing of packets between the two planes), etc. In some embodiments, these one or more components may enable a physical connection between the accelerator 122 and the programming data plane 116 on the same device.

In some embodiments, one or more of these components may not be included in the smartNIC 102, depending in part on whether the programming data plane 116 is included. For example, a data bus between the accelerator 122 and the programming data plane 116 may not be necessitated if the local programming data plane 116 is not included within the smartNIC 102. In some embodiments, even if the programming data plane 116 is included within the smartNIC 102 (and/or the smartNIC 102 includes other components enabling communication between the accelerator 122 and the programming data plane 116), the accelerator 122 may be paired with a remote programming data plane (e.g., remote programming data plane 128 of host B 112). Accordingly, in one example, the programming data plane 116 may perform a reduced set of control functions (e.g., performing no control functions), and at least a portion of the control functions associated with controlling the accelerator 122 may be performed by the remote programming data plane. As depicted in FIG. 1, the smartNIC 102 may be connected to the virtual network 110 via the switch 108.

As introduced above, one or more hosts (e.g., host A 104, host B 112, and/or host C 114, etc.) may, respectively, implement a remote programming data plane (e.g., via a software service). In some embodiments, a remote programming data plane (e.g., remote programming data plane 128) may be responsible for performing, when paired with an accelerator (e.g., accelerator 122), any suitable tasks associated with packet processing. This may include, but is not limited to, determining if a packet and/or flow should be allowed or rejected (e.g., via a security list) by the accelerator 122, determining when an allowed flow should be expired, determining a flow statistics report, determining instructions for programming the accelerator 122, etc. In some embodiments, the remote programming data plane may be enabled to perform similar (e.g., the same) or different (e.g., additional) functions as the local programming data plane 116. In some embodiments, a remote programming data plane may be communicatively connected to the accelerator 122 via a suitable network path (e.g., the virtual network 110 and/or switch 108).

As described herein, it should be understood that the remote programming data plane service of respective devices (e.g., host A 104, host B 112, and/or host C 114, etc.) may be fungible with other remote programming data plane services. For example, suppose that the accelerator 122 is currently paired with remote programming data plane 128 (e.g., of host B 112), and then the remote programming data plane 128 becomes unreachable via the network path by accelerator 122. In this example, remote programming data plane 126 (e.g., of host C 114) may be a redundant (e.g., backup) service, such that it may be paired with accelerator 122 in the event that remote programming data plane 128 becomes unreachable (e.g., by the accelerator 122 and/or by the remote programming data plane 126. As described further herein, any suitable algorithm (e.g., indicating priority of different services, pairing request validation, etc.) may be used to implement a pairing protocol between the accelerator 122 and one or more remote programming data plane services.

In some embodiments, the different programming data planes (e.g., local programming data plane 116 and/or one of the remote programming data planes to which the accelerator 122 is paired) may coordinate (e.g., divide) tasks between each other. For example, in some embodiments, a remote programming data plane 128 that is paired with the accelerator 122 may transmit an instruction (e.g., via a single control packet) the smartNIC 102. The accelerator 122 may receive the single control packet, determine that the packet is a control packet type, and then forward the packet to the programming data plane 116 (e.g., via a data bus, which may be a NOC). The programming data plane 116 may analyze the control packet, and then generate instructions for programming the accelerator 122. In some embodiments, a control packet transmitted by the remote programming data plane 128 to the accelerator 122 may be used to program the accelerator 122 directly (e.g., without involving further packet processing by the local programming data plane 116).

FIG. 2 is a simplified block diagram illustrating an example architecture of an accelerator of an NVD and a remote programming data plane of another device, according to some embodiments. In diagram 200 of FIG. 2, a smartNIC 201 type of NVD is illustrated. The smartNIC 201 includes several elements, including one or more ports (e.g., port X 212 and port Y 214), an accelerator 204, one or more packet queues 206, a data bus 208, a shared memory 210, and a programming data plane 202. In some embodiments, the smartNIC 201 may be similar to the smartNIC 102 of FIG. 1, and/or may operate in a similar contextual environment (e.g., connected to a host computer and/or switch device, operating within a virtual network environment, etc.). As described in reference to FIG. 1, one or more of the components of smartNIC 201 may be optional. For example, in some embodiments, programming data plane 202, data bus 208, packet queues 206, and/or shared memory 210 may be optional. In some embodiments, a component may be included, but used for a different purpose, depending in part on which type(s) of programming data plane (e.g., programming data plane 202 and/or a remote programming data plane, described further herein) the accelerator 204 is paired with.

As described above, in some embodiments, the smartNIC 201 may not include the programming data plane 202 and/or one or more other components. For example, consider smartNIC 250, which includes accelerator 252 (e.g., which may be similar to (e.g., the same as) accelerator 204). In some embodiments, as depicted in FIG. 2, instead of the accelerator 252 being paired with a local programming data plane (e.g., local to the smartNIC 250), the accelerator 252 may be paired with a remote programming data plane service. For example, host 240 and host 244 may be representative devices of a plurality of devices (e.g., candidate host devices). Host 240 may execute a remote programming data plane service 242 and host 244 may execute another remote programming data plane service 246. Each device of the plurality of devices may be connected to the smartNIC 250 via the a network path (e.g., virtual network 248). In one example, the accelerator 252 may receive an instruction to register a pairing with the remote programming data plane 242 of host 240. The accelerator 252 may thereafter exchange information (e.g. control packets and/or requests for instructions) with remote programming data plane 242. Suppose that, at a later time, remote programming data plane 242 becomes unreachable by accelerator 252 via the network path (e.g., virtual network 248). In one example, the accelerator 252 may obtain another instruction that indicates a next (e.g., alternate) remote programming data plane (e.g., remote programming data plane 246) to which the accelerator 252 should attempt to pair with. In some embodiments, as described further herein, the accelerator 252 may obtain pairing instructions via any suitable mechanism. For example, the pairing instruction(s) may be programmed into memory of the accelerator 252. For example, during the manufacturing of the smartNIC 250, the memory may be programmed with instructions (e.g., an IP address, remote service, etc., for contacting a remote host to be paired with.).

As depicted in FIG. 2, it should be understood that any one or more remote programming data planes (e.g., of host 240, host 244, etc.) may, respectively, serve as a suitable replacement for a local programming data plane (e.g., programming data plane 202), with respect to a given accelerator. For example, suppose that accelerator 252 of smartNIC 250 is similar to accelerator 204 of smartNIC 201. In this example, accelerator 252 may be paired with one of the remote programming data planes. This pairing relationship may facilitate similar a relationship to exchange information that programming data plane 202 has with accelerator 204 (e.g., being physically connected on the same smartNIC 201 device). However, in this case, the smartNIC 250 may be simplified (e.g., reduced complexity) to not include a local programming data plane. For example, instead of using one or more of the data bus 208, the shared memory 210, and/or packet queues 206 to communicate between local planes of smartNIC 201, a control packet type may be used to facilitate communication between the remote programming data plane and the accelerator 252 (e.g., via the virtual network 248). In some embodiments, as described herein, a remote programming data plane may provide additional functionality (e.g., with respect to a local programming data plane), at least in part because it may obtain contextual information that may not be as readily available to the local programming data plane (e.g., of smartNIC 201).

In some embodiments, as described herein, a smartNIC that includes both an accelerator and a local programming data plane (e.g., similar to smartNIC 201) may still enable the accelerator (e.g., accelerator 204) to be paired with a remote programming data plane. For example, the programming data plane 202 may be programmed to perform a limited set of control functions. For example, the local programming data plane 202 may be responsible for programming the accelerator 204 to pair with a particular remote programming data plane. Accordingly, it should be understood that any suitable smartNIC (e.g., including any suitable subset of the components of smartNIC 201) may be configured to perform techniques described herein, such as pairing with and/or coordinating packet processing with a remote programming data plane. In cases where the local programming data plane 202 may still be involved in performing one or more functions associated with packet processing, one or more of the components and/or sub-components of smartNIC 201 may be utilized.

Turning to the elements of the smartNIC 201 (and/or smartNIC 250) in further detail, as described herein, the smartNIC 201 may contain one or more ports. For example, port X 212 may correspond to a host port that is connected (e.g., via an Ethernet cable) to a host computing device. Port Y 214 may correspond to a switch port that is connected to a switch device. In some embodiments, a port of the smartNIC 201 may be split (e.g., via a splitter device, such as an Ethernet splitter) into a plurality of ports (e.g., two ports). It should be understood that the smartNIC 201 may include any suitable number of ports. These ports may be physically native to the smartNIC 201, connected to the smartNIC 201 via an external splitter device (e.g., thus, extending the number of ports available to the smartNIC 201), and/or any suitable combination. It should be understood that any of the one or more ports of the smartNIC 201 may be configured to transmit and/or receive network traffic.

Turning to the accelerator 204 (and/or accelerator 252) in further detail, the accelerator 204 may include one or more hardware and/or software components. For example, as depicted in FIG. 2, the accelerator 204 may include a packet buffer 220, one or more processors 222, and a memory 224. In some embodiments, a packet (e.g., a data packet or control packet) may be received at a port of the smartNIC 201 (e.g., port X 212), and then be transmitted to the packet buffer 220. In some embodiments, the packet buffer 220 itself may include memory (e.g., dynamic random access memory (DRAM), static random access memory (SRAM), etc.) and/or one or more processors. The packet buffer 220 may queue packets (e.g., utilizing one or more queues allocated in the memory) that are received from one or more ports of the smartNIC 201 for further processing by the accelerator 204, described further herein. The packet buffer 220 memory may also queue packets that have been processed (e.g., by the accelerator 204, the programming data plane 202, and/or a paired remote programming data plane (e.g., remote programming data plane 242)), and are ready to be routed to another computing device. For example, the packet buffer 220 may queue packets that are ready for transmission to either host A 104 of FIG. 1 or to switch 108 (e.g., for further routing to another host connected to the virtual network 110). In some embodiments, the packet buffer 220 may execute a traffic manager process that coordinates (e.g., including load-balancing) queueing and/or de-queueing packets that are processed by the accelerator 204 and/or a programming data plane (e.g., local or remote).

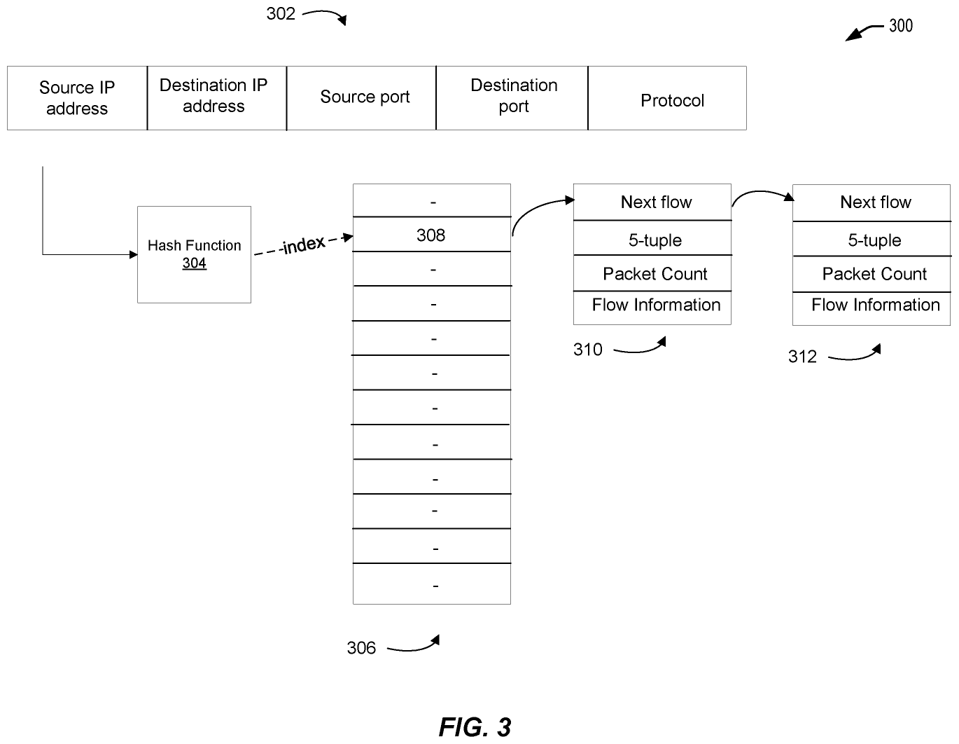

Turning to the processing of a packet by the accelerator 204 (and/or accelerator 252) in further detail, consider an example in which a data packet is received from any suitable host (e.g., from a user device) at a port (e.g., port Y 214) and queued for processing by the traffic manager. In this example, the data packet may be associated with a request for content (e.g., a web page) from a compute instance (e.g., operating a web server) of host A 104. It should be understood that a data packet may contain any suitable payload contents (e.g., text, video, audio, etc.) associated with a particular flow between endpoints. When the data packet is ready to be de-queued, the traffic manager may de-queue the packet and transmit it to a processor 222 of the accelerator 204. In some embodiments, the processor 222 may be specialized to perform match analysis on the packet to facilitate efficient processing of the packet. For example, the processor 222 may be programmable with instructions for performing analysis on a packet (e.g., analyzing packet headers to determine flow information, etc.), and then determining what actions to take (e.g., forwarding the packet, dropping the packet, etc.). When performing this analysis, the processor 222 may perform a look-up into the memory 224 to determine if the data packet is associated with a known (e.g., allowed) flow. As described herein, in some embodiments, the memory 224 may include a cache of the accelerator. The cache may include one or more cache entries. In some embodiments, as illustrated further below with respect to FIG. 3, the cache may include a hash table data structure. Each cache entry may correspond to a particular flow that is being managed by the accelerator 204 (e.g., as an allowed flow).

FIG. 3 is a simplified block diagram illustrating utilization of a cache of the accelerator 204 (and/or accelerator 252) of FIG. 2, according to some embodiments. The diagram 300 depicts a five-tuple 302, a hash function 304, and a hash table 306. The hash table 306 may correspond to a cache, and may include one or more entries (e.g., cache entries). In some embodiments, the hash table 306 may include one or more entries for a given hash (e.g., utilizing a chaining technique, in case there are hash collisions). For example, a hash table entry 308 of the hash table 306 may be associated with (e.g., include) one or more cache entries, for example, cache entry 310 and cache entry 312. A cache entry may include any suitable flow information. For example, as depicted in FIG. 3, the cache entry 310 and cache entry 312, respectively, includes a five-tuple (and/or associated hash) that corresponds to a particular flow, a packet count for the number of packets that have been received by the accelerator for the particular flow, and other flow information (e.g., other flow statistics, timer information, flow routing information, etc.). Each cache entry may also include a pointer to another cache entry (e.g., for another flow). It should be understood that any suitable data structure may be used to maintain the accelerator cache. In some embodiments, a similar cache (e.g., including cache entries for currently managed flows) may be maintained by a programming data plane that is associated (e.g., paired) with the accelerator (e.g., programming data plane 202, and/or a remote programming data plane). It should be understood that the content of the cache entries for respective caches may be the same or different.

Continuing with the operations of the accelerator 204 (and/or accelerator 252) of FIG. 2, and, utilizing FIG. 3 for further illustration, upon receiving a data packet for analysis, the processor 222 of the accelerator 204 may perform a look-up into the accelerator cache (e.g., within the memory 224), which may correspond to the hash table 306. In one example, the processor 222 may analyze one or more headers of the data packet to obtain flow information (e.g., including a five-tuple), which may be similar to the five-tuple 302. For example, a header of the data packet may formatted according to a Transmission Control Protocol (TCP)/Internet Protocol (IP) header protocol, whereby the particular format of the header includes a plurality of different fields. The five-tuple 302 may include five of these fields, including a source IP address, a destination IP address, a source port, a destination port, and a protocol field. In some embodiments, the five-tuple may correspond to a particular (e.g., unique) flow (e.g., connection) between two endpoints. Upon obtaining the five-tuple, the processor 222 may generate a hash of the five-tuple 302 by executing a hash function 304. The output of the hash function 304 may be a hash (e.g., a hash value), which may correspond to any suitable identifier (e.g., a sequence of bits, an alphanumeric sequence, etc.). The hash may be used to index into the hash table 306. For example, suppose that this particular data packet is associated with a particular flow that is already being managed by the accelerator 204. The particular flow may be associated with the cache entry 312 of the hash table 306. In this example, the processor 222 may then identify how to process the data packet based in part on the data within the cache entry 312. For example, the processor 222 may increment the packet count of the particular flow and/or update statistical information associated with the flow. In some embodiments, the processor 222 may log flow information to a log maintained by the accelerator 204. In some embodiments, the cache entry 312 may further include instructions for how to process the data packet. For example, the cache entry 312 may contain instructions indicating a particular host device to route the packet toward. In this example, because the data packet is already associated with a known flow in the accelerator cache (e.g., an approved flow), the accelerator 204 may efficiently forward the data packet to the appropriate destination. For example, as described earlier, the data packet may be forwarded via the host port (e.g., port X 212) to the NIC 106 of host A 104, whereby the web server executing within the compute instance may process the request indicated by the data packet.

As described above, the accelerator 204 (e.g., and/or accelerator 254) may thereby efficiently process packets of known (e.g., approved) flows that may be respectively be tracked (e.g., managed) based in part on the accelerator cache entry data. For example, the accelerator 204 may not transmit the data packet to the programming data plane 202 (and/or a remote programming data plane to which the accelerator is paired) if the accelerator 204 already has instructions for routing packets associated with the flow.

In some embodiments, the accelerator 204 (and/or accelerator 252) may be programmed to coordinate packet processing with a programming data plane (e.g., a local programming plane and/or a remote programming data plane, as described herein). For example, the accelerator 204 may forward a data packet to a programming data plane in a case when the accelerator requests further instructions and/or does not have sufficient information to process the packet. In another example, the accelerator may receive a data packet from a programming data plane to be forwarded on to the intended destination, as indicated by an IP header of the data packet. In yet another example, the accelerator may receive from (and/or send to) the programming data plane a control packet, for example, including control instructions that may be used to program the memory 224 of the accelerator and/or cause the accelerator to perform one or more functions.

Turning to a case in which accelerator 204 is configured to coordinate packet processing with the local programming data plane 202, consider an example in which a data packet is received by the accelerator 204, for example, from a client application (e.g., a web browser) of a user device. In this example, the accelerator 204 determines that this data packet is not associated with a flow already managed by the accelerator 204. Accordingly, the accelerator 204 may determine to request further instructions from the programming data plane 202. The accelerator 204 may then input the data packet into a packet queue 206, which may be one of a plurality of data queues. For example, in some embodiments, each processor of the one or more processors of the programming data plane 202 may be associated with at least one queue per port. In some embodiments, the one or more packet queues 206 may be a component of the accelerator 204. In some embodiments, the packet queues 206 may be a separate component from the accelerator 204. In any case, the packet queues 206 may operate as an interface between the accelerator 204 and the programming data plane 202, whereby packet data (e.g., data packets and/or control packets) may be efficiently routed between the planes. In some embodiments, in part because there may be multiple processors of the programming data plane 202, with one or more corresponding packet queues per processor, the smartNIC may be able to process (e.g., in parallel) a large number of packets per second (e.g., 100 Gigabits/second, 200 Gigabits/second, etc.). For example, as described further herein, the smartNIC 201 (e.g., via the programming data plane 202) may be able to efficiently add new flows to be managed by the accelerator 204.

Continuing with the example above, the data packet may subsequently be de-queued from the packet queue 206 and transmitted to the programming data plane 202 via a data bus 208. In some embodiments, the data bus 208 may correspond to any suitable physical medium that may transport data between elements of the smartNIC 201. For example, the data bus 208 may correspond to a network-on-a-chip (NOC) that includes a network-based subsystem on an integrated circuit of the smartNIC 201. In some embodiments, the data bus 208 may enable data to be transported between the accelerator 204, the programming data plane 202, the packet queue(s) 206, and/or the shared memory 210 of the smartNIC 201.

The programming data plane 202 may include one or more processor units. As depicted in FIG. 2, the programming data plane 203 may include four processor units, for example, processor A 230, processor B 232, processor C 234, and processor D 236. In some embodiments, one or more of these processors may utilize an Advanced Reduced Instruction Set Computing (RISC) Machine (ARM) architecture. In some embodiments, any one or more of the processors may be configured to receive and/or process packets (e.g., data packets and/or control packets). The programming data plane 202 may also include a memory 238 (e.g., SRAM, DRAM, and/or any suitable type of memory). In some embodiments, the memory 238 may also include, among other things, a cache. The cache may be used to managed various flows by the programming data plane 202. In some embodiments, the programming data plane 202 may be configured to analyze packets received from the accelerator 204 and determine instructions for processing those packets. In some embodiments, the programming data plane 202 may itself forward packets (e.g., via the accelerator 204) to another device external to the smartNIC 201. In some embodiments, the programming data plane 202 may also and/or alternatively be configured to program the accelerator 204 with instructions for processing subsequent packets associated with particular flows. For example, the programming data plane 202 may instruct the accelerator 204 to add a cache entry for a flow that has been approved by the programming data plane 202.

Continuing with the example above, suppose that the data packet de-queued from the packet queue 206 is received by the programming data plane 202 via the data bus 208 by processor A 230. In this example, processor A 230 may analyze the data packet and determine that this packet is associated with a new flow (e.g., not previously authorized by the programming data plane 202). As described herein, in this example, it should be understood that processor A 230 may be a representative processor of the plurality of processors of the programming data plane 202. The processor A 230 may determine that this flow is to be allowed (e.g., authorized), for example, based on a security list of rules regarding types of flows, device endpoints, and/or traffic patterns that are to be allowed (and/or disallowed). It should be understood that the programming data plane 202 may be configured to perform any suitable analysis and/or actions on the data packet and/or other network data traffic. For example, the programming data plane 202 may implement a firewall, compile statistical data in a statistics report regarding flow traffic, report flow data to customers, etc.

In this example, having determined that this new flow is to be allowed, the processor A 230 may generate a new cache entry for the new flow in the cache of the programming data plane 202. For example, the cache may include a similar hash table data structure as depicted in FIG. 3. The processor A 230 may generate a hash for the five-tuple of the data packet, and then generate a new cache entry to be added to the hash table. In at least this way, the programming data plane 202 may also keep track of flows managed by the smartNIC 201. The processor A 230 may also determine to instruct the accelerator 204 to add a new cache entry to the accelerator cache. For example, the programming data plane 202 may invoke an API call of an API that is implemented via the shared memory 210. For example, the processor A 230 may write instructions to the shared memory 210. In one embodiment, the accelerator 204 may poll the shared memory 210 to retrieve (e.g., read) the programming instructions from the shared memory 210. In this case, the programming instructions may instruct the accelerator 204 to add a new cache entry for the new approved flow to the accelerator cache. Subsequent data packets received by the accelerator 204 for that particular approved flow may then be quickly routed (e.g., to another host), without involving the programming data plane 202, as described herein. It should be understood that the programming data plane 202 may transmit any suitable instructions to the accelerator via the shared memory 210 (e.g., instructions to add a new cache entry, remove a cache entry, log packet information, etc.).

In some embodiments, having processed the data packet and provided instructions for programming the accelerator (e.g., for handling subsequent data packets related to the approved flow), the processor A 230 may transmit the data packet back to the accelerator 204 (e.g., via the data bus 208 and/or queue the packet in one of the packet queues 206), whereby the accelerator 204 may then forward the data packet to the appropriate destination (e.g., host A 104 of FIG. 1).

In some embodiments, as described herein, an accelerator (e.g., accelerator 204 or accelerator 252) may be paired with a remote programming data plane (e.g., remote programming data plane 242 or remote programming data plane 246). Accordingly, instead of the accelerator forwarding data packets to and/or receiving programming instructions from a local programming data plane (e.g., programming data plane 202), the accelerator may exchange information (e.g., control information, etc.) with the paired remote programming data plane. For example, consider another case in which accelerator 252 of smartNIC 250 (and/or accelerator 204 of smartNIC 201, as the case may be) is paired to remote programming data plane 246 of host 244.

In this example, and, as described further herein, the accelerator 252 may obtain an instruction, which may be pre-programmed to the accelerator memory and/or obtained via an encrypted control packet (over a network path) that includes pairing instructions. In any case, upon obtaining the instruction, the accelerator 252 may register registration data indicating a pairing with the remote programming data plane 246. Upon the accelerator 252 being paired with the remote programming data plane 242, information may be exchanged between the accelerator 252 and the remote programming data plane 242 via control packets (and/or data packets) that are transmitted via the network path (e.g., the virtual network 248). In some embodiments, similar information may be exchanged (e.g., via control packets and/or data packets) between the accelerator 252 and the remote programming data plane 242 as may otherwise be exchanged between an accelerator (e.g., accelerator 204) and a local programming data plane (e.g., programming data plane 202). In some embodiments, a remote programming data plane may be designed to perform similar tasks, as described in reference to the local programming data plane 202.

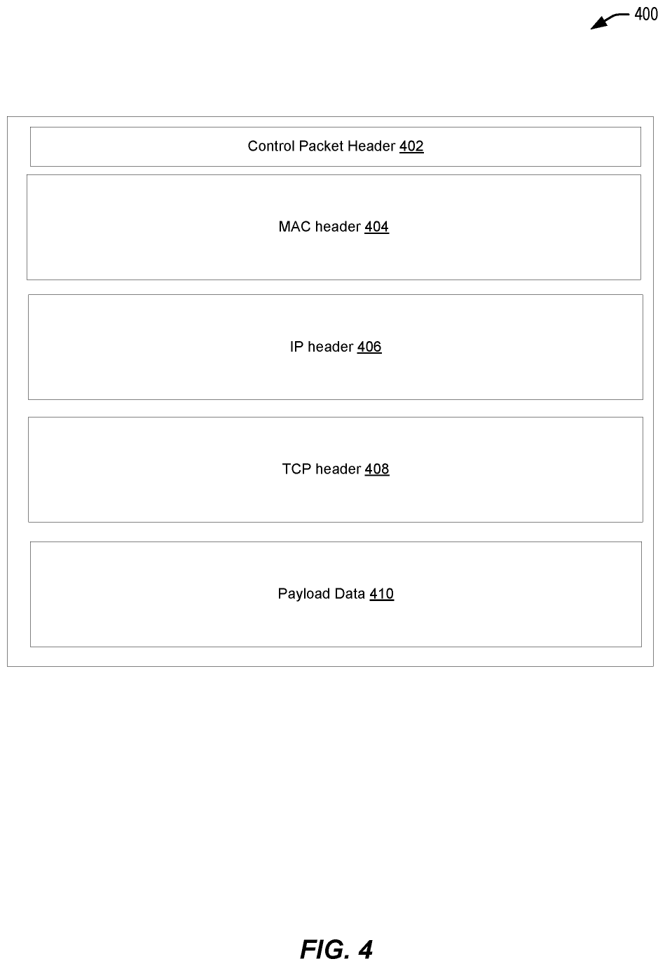

In some embodiments, as described further herein (e.g., with reference to FIG. 4), a control packet may be formatted such that the packet may be routed via the virtual network 248 (e.g., using IP tunneling, etc.), similar to other data packets that may include normal network traffic payloads (e.g., requests for a web page, video stream data, etc.). It should be understood that, in part because the control packets (and/or data packets) may both be routable via the same network path (e.g., using similar routing protocols, such as IP, TCP, etc.), techniques described herein may enable the paired remote programming data plane 242 to perform similar operations as the local programming data plane 202.

FIG. 4 is another simplified block diagram illustrating an example format for a control packet, according to some embodiments. The packet format 400 of FIG. 4 includes a plurality of headers and a payload data 410. The plurality of headers includes a control packet header 402, a Media Access Control (MAC) header 404, an Internet Protocol (IP) header 406, and a Transmission Control Protocol (TCP) header 408. In some embodiments, the MAC header 404, the IP header 406, and/or the TCP header 408 may be formatted, according to industry standards, for example, according to the Open System Interconnection (OSI) Model. In some embodiments, any suitable packet header(s) may be utilized for the control packet format 400. For example, in a case where an Ethernet frame may utilize a VLAN tag, an Institute of Electrical and Electronics Engineers (IEEE) 802.1Q standard may be used within a modified Ethernet frame header (e.g., a modified MAC header 404). As described herein, a VLAN tag may be used, for example, to identify which VLAN a particular packet belongs, thus enabling the smartNIC (and other computing resources of the CSPI) to support virtual network routing. In some embodiments, any one or more fields of the packet headers and/or payload data 410 may be associated with flow information that may be used to identify a particular flow associated with a given packet.

It should be understood that one or more of the headers of the packet format 400 for a control packet may be similar (e.g., same) as the packet format for a data packet, described herein. For example, as referenced with respect to the five-tuple 302 of FIG. 3, the one or more headers of the packet format 400 may include fields that may be used to determine a five-tuple. As described herein, the five-tuple may be used to identify a particular flow. For example, the five-tuple may be used to generate a hash that indexes into a cache (e.g., a cache of an accelerator and/or a cache of a programming data plane). In some embodiments, based at least in part on the control packet format and the data packet format utilizing a similar (e.g., same) format, both packet types may utilize the same network path (e.g., virtual network 248) to exchange information between an accelerator and a remote programming data plane. In some embodiments, a control packet may encapsulate a data packet (e.g., utilizing the control packet header 402).

In some embodiments, the control packet header 402 may be prepended or appended to the control packet. In some embodiments, the control packet header 402 may be included at any suitable position (e.g., among the headers and/or payload) within a control packet. The control packet header 402 may correspond to any suitable format, for example, a bit string of N bits (e.g., 8 bits) that is prepended (or appended) to the packet. In some embodiments, the bit string may indicate a flag that corresponds to an identifier of some control information. In some embodiments, control information may correspond to any suitable information associated with processing packets (e.g., pairing information, requests for instructions for processing a flow, an alert about a particular flow cache entry, and instruction for expiring a flow, flow statistics, etc.). For example, the bit string may identify that a flow indicated by the five-tuple of this particular control packet is a candidate for deletion from the cache of the accelerator. In another example, the bit string may identify statistical data about the particular flow (e.g., a number of packets that have been received and/or processed by the accelerator for the particular flow). In some embodiments, the control information may also and/or alternatively be included within the payload data 410 of the control packet. It should be understood that any suitable combination of header fields and/or payload data may be used to transmit control information within a control packet from a first plane to a second plane (e.g., an accelerator to a remote programming data plane, and/or vice versa). In some embodiments, a control packet may also be transmitted between an accelerator and a local programming data plane. In some embodiments, a control packet header 402 may be used to differentiate between a data packet and a control packet.

As described above, in some embodiments, the payload data 410 field of a control packet may also (and/or alternatively) be used to include information used to coordinate packet processing between an accelerator and a programming data plane (e.g., a local programming data plane or a remote programming data plane). In some embodiments, a single control packet (e.g., without requiring a TCP connection setup process) may be used to communicate information between an accelerator and a remote programming data plane. For example, a remote programming data plane may transmit a single control packet that includes instructions (e.g., control information) in the payload data 410. In some embodiments, the instructions may indicate for example, flow expiry information (e.g., which flow should be expired by the accelerator), a request for flow statistics, an updated security list (e.g., indicating that a particular flow is not allowed), a request to forward a packet, a flow policy for a particular flow (e.g., indicating a level of quality of service (QoS) that a flow should receive), etc. Conversely, the accelerator may also transmit a single control packet that may include control information. This may include, for example, a response to the request for flow statistics (e.g., a list of flow statistics), information about a flow that is a flow cache entry that is a candidate for removal, a request for instructions about how to process a data packet, etc. In some embodiments, a single control packet may contain information suitable for processing (e.g., by the receiving party) the information that is self-contained within the single control packet. In some embodiments, the single control packet may be less than or equal to a jumbo frame size. In some embodiments, a jumbo frame may include up to 9,000 bytes of payload. It should be understood that, by structuring control information to be self-contained within a single control packet (e.g., within a jumbo frame), embodiments herein may be performed without necessitating a connection (e.g., a TCP connection) set-up and/or tear-down. In some embodiments, this may facilitate more efficient communication between an accelerator and a remote programming control plane. In some embodiments, a TCP connection may be established between the accelerator and a remote programming control plane. For example, an accelerator may determine to transmit a stream of packets (e.g., control packets) to a paired remote programming control plane.

Turning back to FIG. 2, as described above, a remote programming data plane (e.g., remote programming data plane 246) may be paired with an accelerator (e.g., accelerator 252, or accelerator 204). Consider an example in which the accelerator 252 receives a data packet from another host. The accelerator 252 determines that the data packet should be further processed, in part because the data packet is not associated with an existing cache entry of the accelerator 252. The accelerator 252 may then generate a single control packet that is formatted similarly to as described in reference to FIG. 4. In one example, the single control packet may include (e.g., encapsulate) information from the data packet (e.g., header information, payload data, etc.). The accelerator 252 may then transmit the single control packet to the host 240 to be processed by the remote programming data plane 242. As described herein, the remote programming data plane 242 may contain similar components as the programming data plane 202, and/or process packets in a similar manner (e.g., utilizing a queueing mechanism) as described with respect to programming data plane 202. For example, the remote programming data plane 242 may utilize one or more processors and/or memory of host 240 to process the single control packet received from the smartNIC 250. Upon processing the single control packet, the remote programming data plane 242 may generate a response message (e.g., included within another single control packet) and transmit that message to the accelerator 252 via the network path. In this example, the response message may indicate that the data packet should be forwarded to the intended destination and then logged. In another example, the response message may include an instruction indicating that the accelerator 252 should add a new cache entry (e.g., for a new approved flow) to the accelerator cache. It should be understood that an accelerator may exchange any suitable information with a remote programming data plane. This exchange may be performed according to any suitable mechanism (e.g., via a single control packet, via a TCP connection, etc.).

In some embodiments, a smartNIC and/or host described herein (e.g., smartNIC 201 and/or smartNIC 25) may include other hardware and/or software elements and/or implement other functions. For example, the smartNIC 250 may include one or more cryptographic functions that are configured to encrypt and/or decrypt packet data. In another example, the smartNIC 250 may include a function to compute a Cyclic Redundancy Check (CRC) code. In some embodiments, the smartNIC 250 may be configured to encapsulate and/or de-capsulate a packet (e.g., a data packet or control packet), for example, to facilitate packet routing over a virtual network. In some embodiments, any one or more of these functions may be implemented in any suitable component of the smartNIC 250 (e.g., the accelerator 252). In one example, the smartNIC 250 may encrypt a control packet and send it to the remote programming data plane 242. Upon receiving the encrypted control packet, the remote programming data plane 242 may decrypt and process the packet. It should be understood that the smartNIC 250 and/or other hosts may utilize suitable security protocol (e.g., IPsec) to transmit secure information. In some embodiments, IPsec may be used for any suitable purpose, for example, to establish a secure pairing, to communicate programming instructions, to transmit requests for packet processing instructions, etc.

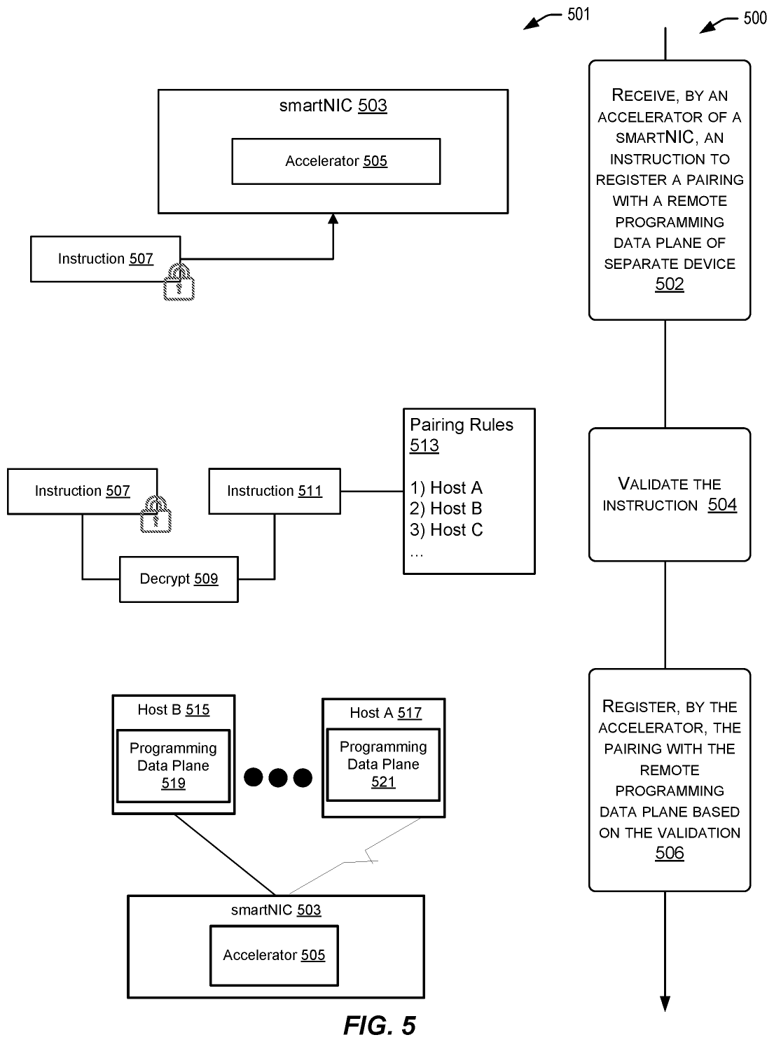

FIG. 5 is a simplified flow diagram illustrating an example technique for pairing an accelerator of an NVD with a remote programming data plane of another device, according to some embodiments. The process 500 is an example process for pairing an accelerator of a smartNIC with a remote programming data plane of another device that is separate (e.g., physically distinct) from the smartNIC.

The diagram 501 depicts example states that correspond to the blocks of the process 500. The diagram 501 includes, among other elements, a smartNIC 503, whereby the smartNIC 503 includes an accelerator 505 (e.g., a data plane). The diagram 501 also includes host B 515 and host A 517, which may be representative of devices that may respectively implement a remote programming data plane. It should be understood that, while smartNIC 503 is depicted without including a local programming data plane component, embodiments should not be construed to be so limited. For example, process 500 may be performed between accelerator 204 of smartNIC 201 (e.g., whereby the smartNIC 201 also includes a local programming data plane) and another device that executes a remote programming data plane. It should be understood that any suitable computing device may be used to implement a remote programming data plane. In some embodiments, the smartNIC 503 may be connected to a host via a network path (e.g., virtual network 248 of FIG. 2).

Turning to process 500 in further detail, the process 500 begins at block 502, whereby an accelerator of a smartNIC receives an instruction to register a pairing with a remote programming data plane of a separate device. For example, using diagram 501 for illustration, smartNIC 503 may receive (e.g., obtain) instruction 507. In some embodiments, the instruction 507 may be obtained at any suitable time. For example, the instruction 507 may be received during manufacturing of the smartNIC 503, whereby an instruction is stored into memory. When the smartNIC 503 activated, the smartNIC 503 may retrieve the instruction. In one example, the instruction may indicate a specific device (e.g., an IP address) to pair with. In another example, the instruction may instruct the smartNIC 503 to transmit a request to a particular (e.g., pre-defined) IP address (e.g., a central server). The server may receive and analyze the instruction, and then send a response with another instruction that indicates a particular host device that the accelerator 505 should pair with. In another example, the accelerator 505 may receive the instruction from a local programming data plane (e.g., in the case where the smartNIC is similar to smartNIC 201 of FIG. 2). For example, the local programming data plane may be responsible for maintaining a list of rules, indicating a priority list for which remote programming data planes the accelerator should be paired with. If, at some point in time after the smartNIC 503 is already in operation, an already-paired remote programming data plane is unavailable (e.g., unreachable, as depicted in diagram 501 with respect to remote programming data plane 521 of host A 517), the accelerator may request from the local programming data plane (and/or a central server) the instruction indicating an alternative remote programming data plane to pair with. It should be understood that the accelerator 505 may receive instructions for pairing at any suitable time and/or from any suitable device/component. In some embodiments, the instruction 507 may be included within a control packet, as described in reference to FIG. 4. For example, if the instruction 507 received from another device via a network path, the instruction 507 may be transmitted within a single control packet. In some embodiments, the instruction 507 may be encrypted (e.g., according to IPsec).

At block 504, the accelerator validates the instruction. For example, as depicted in diagram 501, the instruction 507 may be encrypted. The accelerator 505 may execute a decryption function 509 to obtain a decrypted instruction 511. In some embodiments, the validation may be performed by successfully obtaining decrypted instruction 511. In some embodiments, the validation may also (and/or alternatively) consist of one or more other tasks. For example, the accelerator 505 may compare the decrypted instruction 511 with one or more pairing rules 513 (e.g., stored by the accelerator 505), as depicted in diagram 501. For example, suppose that the decrypted instruction 511 indicates that two host devices (e.g., host B and host C) are currently available for pairing (e.g., respectively, implementing a remote programming data plane). In this example, the accelerator 505 may reference the pairing rules 513, and determine that, since host A (e.g., the first choice) is unavailable, the accelerator 505 should pair with the remote programming data plane of host B (e.g., since it is ranked higher than host C). In some embodiments, if no host is listed in the decrypted instruction 511 that matches a host in the pairing rules 513, the validation may fail. In some embodiments, if the validation fails, the accelerator 505 may perform any suitable task. For example, the accelerator 505 may stop forwarding packets. In another example, the accelerator 505 may send an alert message to an administrator device, indicating that attention is required. In some embodiments, the instruction 507 may not be encrypted. In some embodiments, one or more operations of block 504 may be optionally performed, for example, if the instruction is received from a trusted source (e.g., from a local programming data plane). In some embodiments, if no remote programming data plane is reachable and a local programming data plane is available on the smartNIC 503, the accelerator 505 may default to pair with the local programming data plane. It should be understood that any suitable validation mechanism may be performed by the smartNIC 503.

At block 506, the accelerator registers the pairing with the remote programming data plane. For example, suppose that, as described above and depicted in diagram 501, the accelerator 505 was previously paired with remote programming data plane 521 of host A 517, and that the remote programming data plane 521 is currently unreachable. In this example, the accelerator 505 determines to register a new pairing with remote programming data plane 519 of host B 515. Accordingly, the accelerator 505 stores new registration data indicating the new pairing between the accelerator 505 and the remote programming data plane 519. In some embodiments, the registration may be performed subsequent to confirming a successful validation of the instruction at block 504. In some embodiments, as part of registering the new pairing, the accelerator 505 may transmit a message (e.g., a single control packet) to remote programming data plane 519 that indicates the new pairing relationship. In this example, the remote programming data plane 519 may respond with a confirmation of the pairing. In some embodiments, the remote programming data plane 519 may itself store the pairing relationship with the accelerator 505. In some embodiments, any suitable data may be stored (e.g., by either device) to indicate the pairing relationship, including, but not limited to, an IP address of the paired device, a port number of the pair device, cryptographic information suitable for encrypting and/or decrypting messages to/from the paired party, etc.

In some embodiments, any suitable protocol (e.g., “handshake”) may be performed between devices to mutually register a pairing. For example, in a case where the smartNIC 503 includes a local programming data plane (e.g., which may be similar to programming data plane 202 of FIG. 2), the local programming data plane may coordinate one or more tasks associated with pairing the smartNIC 503 with the appropriate remote programming data plane.

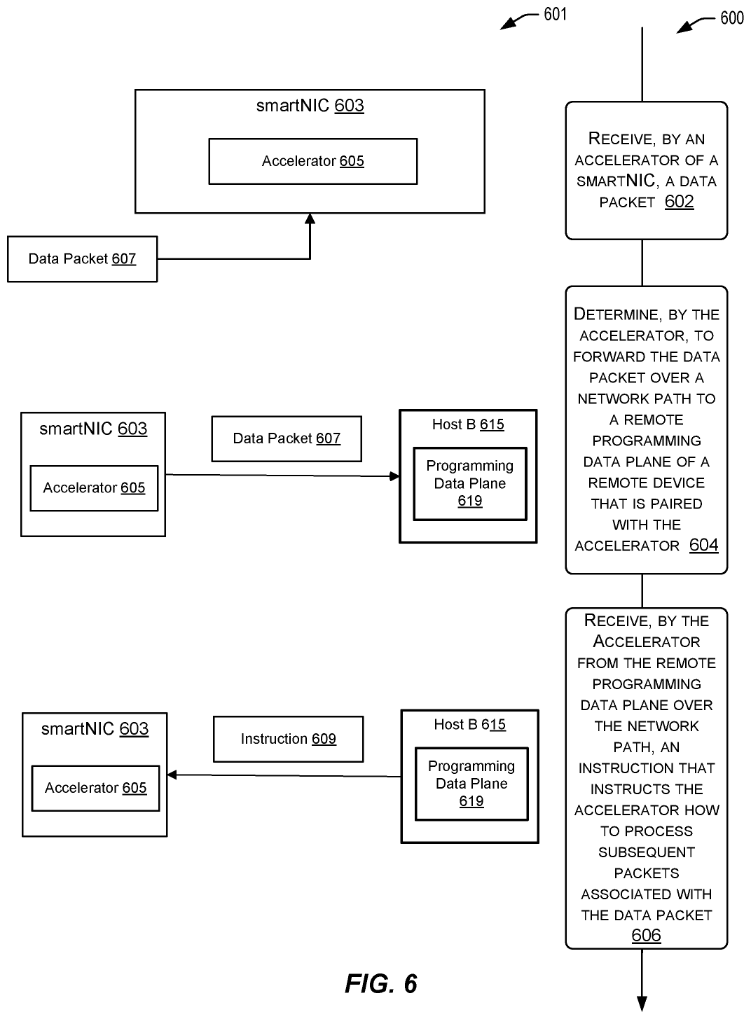

In another example, establishing a pairing may involve establishing a connection (e.g., a TCP connection, or other suitable connection that involves a connection setup/teardown process) between a smartNIC and a host. For example, process 500 may further include one or more steps whereby the smartNIC 503 establishes a TCP connection with host B 515. The TCP connection may be used to transmit any suitable information between the devices, including, for example, an instruction to pair with the other device, cryptographic key information, etc. In some embodiments, in addition to (and/or alternatively to) the TCP connection being used to establish the pairing, the TCP connection may be further used during process 600 of FIG. 6 (described further herein), for example, to coordinate flow processing between the paired planes. In some embodiments, a connection may not be established between the two devices. For example, as described herein (e.g., with respect to FIG. 4), a single control packet format may be used to establish a pairing and/or coordinate flow processing between the two devices. In some embodiments, a header and/or payload of the single control packet format may be suitable for communicating information (e.g., to facilitate the pairing, communicate instructions, packet data, etc.), without necessitating a stream of packets (that may otherwise be involved in a TCP connection). In some embodiments, if a single control packet format is used, the devices may utilize any suitable retry mechanism, in case an expected response is not received (e.g., within a predetermined wait time). For example, a control packet may be resent to the destination device up to N times. If a response is still not received, the accelerator 505 may be repaired with another device.

Furthermore, it should also be understood that any suitable protocol may be used to determine when to update (e.g., change, delete, and/or add) a pairing relationship. For example, at some point in time following block 506, the accelerator 505 may receive an instruction from a trusted central server, indicating that the accelerator 505 should be repaired to host A 517 (e.g., which may now be reachable).

FIG. 6 is another simplified flow diagram illustrating an example process 600 for efficiently coordinating management of flows between an accelerator of an NVD and a remote programming data plane of another device, according to some embodiments. The diagram 601 depicts example states that correspond to the blocks of process 600. The diagram 601 includes, among other elements, a smartNIC 603 (e.g., which may be similar to smartNIC 503 of FIG. 5) and a host B 616 (e.g., which may be similar to host B 515). In some embodiments, the process 600 may follow one or more steps of process 500. For example, the smartNIC 603 may already be paired with a remote programming data plane 619 of host B 615.

Process 600 depicts an example in which a data packet 607 is received by an accelerator 605 of smartNIC 603 and then forwarded to a paired remote programming data plane 619 of host B 616 for further processing (e.g., to request further instructions for processing the data packet). The remote programming data plane 619 then determines an instruction 609 and then sends the instruction 609 back to the smartNIC 603 for processing the data packet 607.

Turning to process 600 in further detail, the process 600 begins at block 602, whereby an accelerator of a smartNIC receives a data packet. For example, suppose that smartNIC 603 (e.g., which may also be similar to smartNIC 102) receives data packet 607 from a host (e.g., a user device) connected to virtual network 110. In this example, the data packet may correspond to a request for a web page to be served from host A 104, which may be executing a web server. The accelerator 605 receives the data packet 607 and then determines how to process the packet. In this case, the data packet 607 may not be associated with an existing flow that is managed by the accelerator 605. Accordingly, the accelerator 605 may request further instructions for processing the packet (e.g., whether to forward the packet to host A 104, drop the packet, log the packet, and/or perform any other suitable operation).

At block 604, the accelerator determines to forward the data packet over a network path to a remote programming data plane of a remote device that is paired with the accelerator. Continuing with diagram 601 for illustration, the accelerator 605 of smartNIC 603 may transmit the data packet 607 via the virtual network 110 (e.g., the network path) to the remote programming data plane 619 of host B 615, which it is paired with. In some embodiments, instead of (and/or in addition to) transmitting the data packet 607 to the remote programming data plane 619, the accelerator 605 may transmit a single control packet. For example, the single control packet may include metadata associated with the data packet 607 (e.g., header information, payload information, etc.). In some embodiments, the single control packet may encapsulate the data packet.

At block 606, the accelerator may receive from the remote programming data plane over the network path an instruction that instructs the accelerator how to process subsequent packets associated with the data packet. In some embodiments, the remote programming data plane 619 may first confirm (e.g., validate) that the accelerator 605 is paired with remote programming data plane 619. In some embodiments, the remote programming data plane 619 may further confirm that the data packet 607 (and/or control packet) is a valid packet received from paired accelerator 605. For example, the data packet 607 (and/or control packet) may be encrypted by the accelerator 605 and subsequently successfully decrypted by the remote programming data plane 619 (e.g., using a shared symmetric key, a private key, etc.). Upon confirming the pairing and/or validating the packet, the remote programming data plane 619 may analyze the packet. In this example, the remote programming data plane 619 may determine that the data packet 607 is associated with a device that is allowed to request/receive flow traffic from host A 104. For example, the requesting device may be recently added to a security list that is maintained by the host B 615, whereby host B 615 may operate another service that frequently updates the security list based on changes to the network environment (e.g., including new customers added, new QoS profiles for customers, resource availability changes, etc.). The remote programming data plane 619 (e.g., running as a service) may interact with the other service to retrieve the updated security list, which may then be used to determine an instruction 609 for processing the data packet 607. In this example, the instruction 609 may indicate that the accelerator 605 should add a new cache entry for a new flow. In some embodiments, the new cache entry may be in accordance with (e.g., defined by) metadata (e.g., header information) of the data packet 607. In some embodiments, the instruction 609 may further instruct the accelerator 605 to forward data packet 607 to the intended destination and log the packet 607. It should be understood that any suitable one or more instructions may be included within instruction 609. Upon the accelerator 605 receiving the instruction 609, the accelerator 605 may validate the instruction and then perform one or more tasks in accordance with the instruction.

Although process 600 depicts one example process of an interaction to coordinate management of a flow between an accelerator and a remote programming data plane, embodiments should not be construed to be so limited. For example, instead of the accelerator 605 initiating an interaction with the paired remote programming data plane 619, the remote programming data plane 619 may initiate an interaction. For example, the remote programming data plane 619 may transmit a single control packet that requests for the accelerator 605 to provide a log of statistics for flows that the accelerator 605 has processed (e.g., within a predetermined amount of time). In another example, the remote programming data plane 619 may transmit a single control packet that instructs the accelerator 605 to update a security list or other rule (e.g., QoS policy) for a particular flow. In yet another example, consider a case in which the smartNIC 603 also includes a local programming data plane. In some embodiments, coordination between the accelerator 605 and the remote programming data plane 619 may be further mediated by the local programming data plane. For example, instead of the accelerator 605 directly processing the instruction 609 (e.g., received within a single control packet) at block 606, the accelerator 605 may transmit the instruction 609 to the local programming data plane for further processing. The local programming data plane may then process the instruction 609, and then instruct the accelerator 605 how to process the data packet 607.

Accordingly, in some embodiments, the accelerator 605, the remote programming data plane 619, and/or a local programming data plane of the smartNIC may coordinate sharing of roles. In some embodiments, the division of roles may be determined based in part on considering various goals, including, but not limited to, simplifying the smartNIC design and increasing reliability, improving contextual awareness (e.g., of the network environment) such that instructions provided (e.g., by the remote programming data plane) are more optimally tuned, improving efficiency in processing packets by the accelerator, etc.

As described above, in some embodiments, communications between the accelerator 605 and the remote programming data plane 619 may occur using any suitable protocol. For example, the instruction 609 may be transmitted via a single control packet, without requiring (e.g., independent of) an established connection between the devices. In some embodiments, instruction 609 (and/or subsequent instructions) may be transmitted within the context of an established connection. In some embodiments, the connection (e.g., a TCP) may be terminated at any suitable time (e.g., upon termination of a pairing between devices).

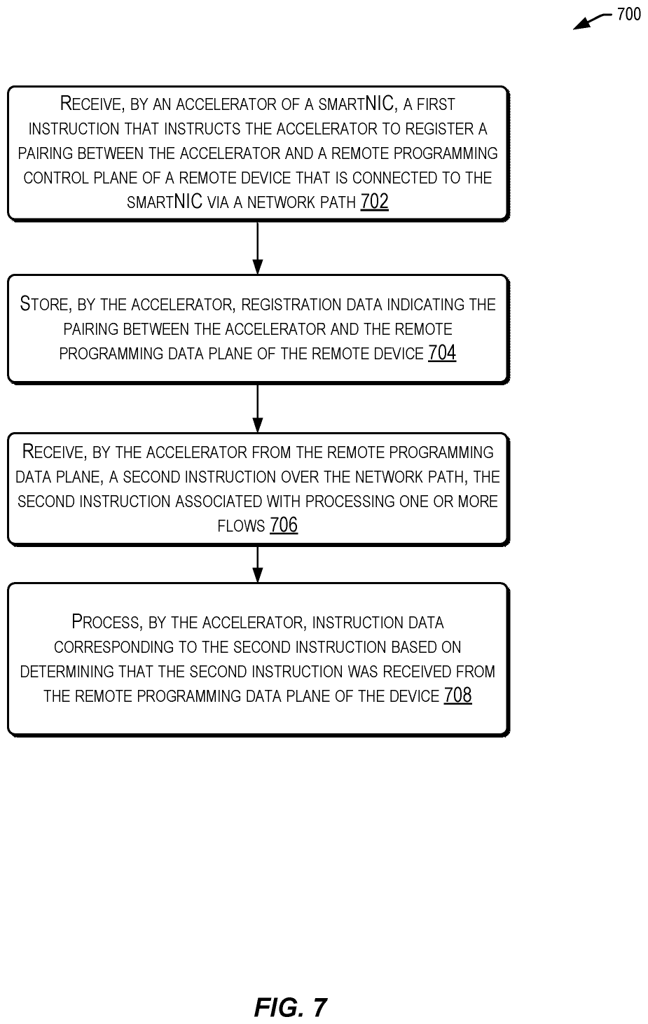

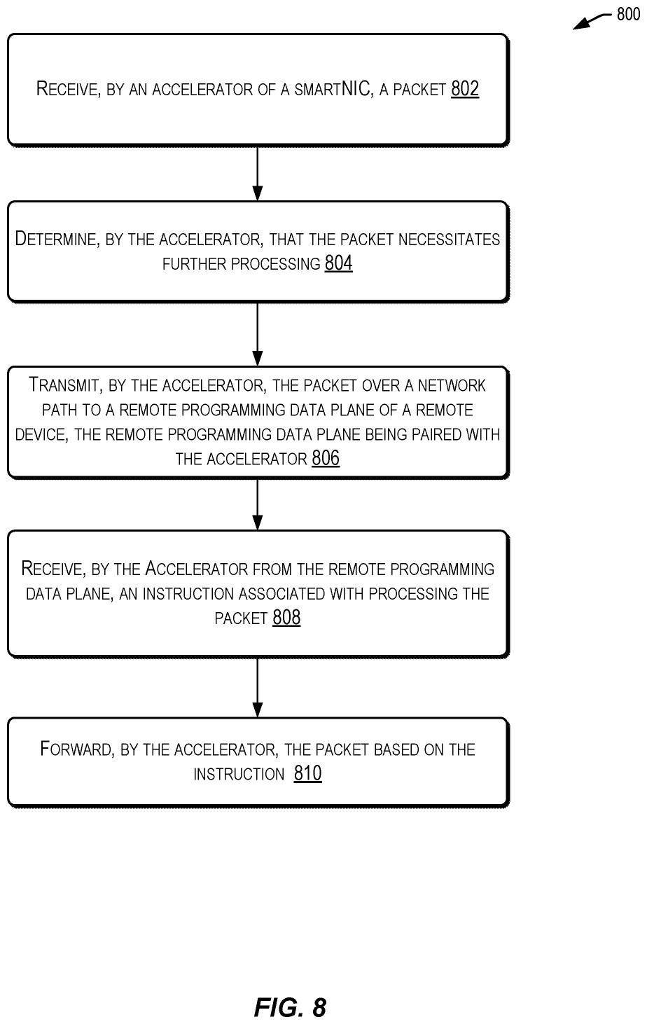

FIG. 7 is another simplified flow diagram illustrating an example process for pairing an accelerator of an NVD with a remote programming data plane of another device, according to some embodiments. In some embodiments, process 700 of FIG. 7 (and/or process 800 of FIG. 8 may be performed by an NVD (e.g., a smartNIC device), which may be similar to any of the NVD's described herein. In some embodiments, one or more operations of process 700 may be similar to as described in reference to FIG. 5 and/or FIG. 6.

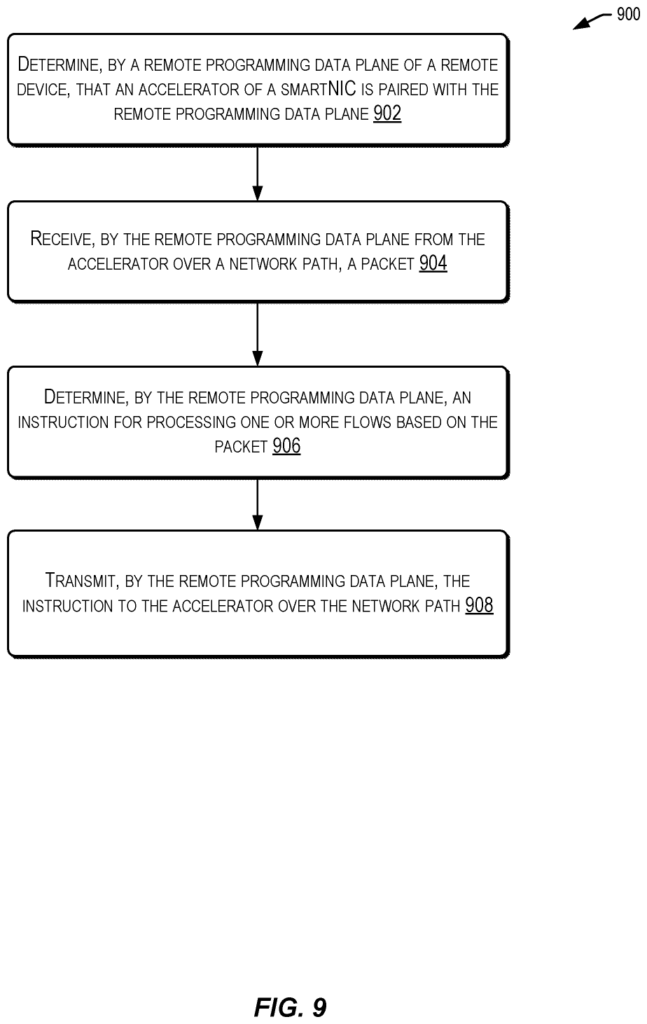

Process 700, 800, and 900 (of FIG. 9) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

At block 702, an accelerator of a smartNIC may receive a first instruction that instructs the accelerator to register a pairing between the accelerator and a remote programming data plane of a device that is connected to the smartNIC via a network path. In some embodiments, the device may be a remote device that is physical distinct from the smartNIC. In some embodiments, one or more operations of block 702 may be similar to as described in reference to block 502 of FIG. 5. For example, the first instruction may be received (e.g., obtained) by the accelerator from any suitable location (e.g., a local programming data plane, via the network path from a remote programming data plane of another device, via the network path from a second device such as a central server, etc.) and at any suitable time. For example, the first instruction may be received (and/or stored) by the accelerator memory during a time that the smartNIC was manufactured. In another example, the first instruction may be received at runtime, when the accelerator requests for the first instruction from a central (e.g., coordinating) server. For example, the accelerator may determine that a second pairing (e.g., a previous pairing) with another remote programming data plane is defective (e.g., the respective host is unreachable via the network path). Accordingly, the accelerator may contact another entity (e.g., the local programming data plane, a central server, etc.) to receive a new instruction (e.g., the first instruction) that indicates which alternate remote programming data plane the accelerator should be paired (and/or re-paired) with. In some embodiments, the first instruction (and/or any subsequent messages described herein, in reference to process 700, 800, or 900) may transmitted via any suitable mechanism (e.g., protocol). For example, as described herein, the first instruction may be transmitted via the network path within a single control packet that is independent of a connection (e.g., between the smartNIC and the device transmitting the first instruction). In some embodiments, the first instruction may be transmitted within a connection context (e.g., a TCP connection).

At block 704, the accelerator may store registration data indicating the pairing between the accelerator and the remote programming data plane of the remote device. In some embodiments, one or more operations of block 704 may be similar to as described in reference to block 504 and/or 505 of FIG. 5. For example, the accelerator may first validate the first instruction. In some embodiments, the accelerator may validate the first instruction based in part on successfully decrypting (e.g., utilizing a cryptographic key, such as a symmetric key) a packet containing the first instruction. In some embodiments, the accelerator then store the registration data within memory to indicate the pairing. For example, the registration data may correspond to an IP address of the device that executes the remote programming data plane, and/or any suitable identifying information for the remote programming data plane. In some embodiments, the registration data may include authentication data (e.g., cryptographic key(s)) used to authenticate subsequent packets transmitted to/received from the remote programming data plane. In some embodiments, for example, if the smartNIC also contains a local programming data plane, the registration data may be stored within memory of the local programming data plane. In some embodiments, the pairing indicates that the accelerator is configured to perform at least one of: (I) accepting subsequent programming instructions from the remote programming data plane to program the accelerator, (II) rejecting subsequent programming instructions from other devices to program the accelerator (e.g., upon confirming this new/updated pairing), or (III) forwarding at least a portion of packets received by the accelerator to the remote programming data plane.

At block 706, the accelerator may receive from the remote programming data plane a second instruction over the network path. In some embodiments, the second instruction may be associated with processing one or more flows. In some embodiments, one or more operations of block 706 may be similar to as described in reference to block 606 of FIG. 6. For example, the second instruction may instruct the accelerator to create a new cache entry for an allowed flow, such that subsequent packets associated with the allowed flow will be automatically forwarded by the accelerator to the intended destination. In some embodiments, the second instruction may correspond to any suitable instruction, including, but not limited to, indicating that a flow is to be expired, updated programming instructions (e.g., QoS policies) for a particular flow, a security list update (e.g., including allowed and/or disallowed flows), a request for flow statistics, etc. In some embodiments, the second instruction may be transmitted by the remote programming data plane in response a packet (e.g., a data packet type or control packet type) received from the accelerator (e.g., similar to as described in reference to block 602 and/or 604 of FIG. 6). As described herein, in some embodiments, the second instruction is included within a single control packet, whereby the single control packet has characteristics corresponding to at least one of: (I) being formatted according to an Internet Protocol (IP) header, a source address of the header identifying the remote programming data plane, (II) having a payload that fits within a jumbo frame, or (III) including the second instruction within a predefined data structure of the payload of the single control packet.

At block 708, the accelerator may process instruction data corresponding to the second instruction based on determining that the second instruction was received from the remote programming data plane of the device. In some embodiments, one or more operations of block 708 may be similar to as described in reference to block 606 of FIG. 6. In some embodiments, the accelerator may first confirm (e.g., validate) that the accelerator is paired with the remote programming data plane of the device (e.g., as described in reference to block 704), and then may process the second instruction. For example, in a case where the second instruction corresponds to programming instructions to generate a new cache entry for a newly allowed flow, the accelerator may process the instruction data by generating the new cache entry. In another example, for example, if the second instruction requests information (e.g., flow statistics) from the accelerator, the accelerator may retrieve a flow statistics log from memory and then transmit the flow statistics (e.g., via a single control packet or a TCP connection) to the remote programming data plane. It should be understood that any suitable steps may be performed to process the instruction data, including, but not limited to, programming instructions to memory, forwarding packet-associated data to the remote programming data plane, removing data from memory, forwarding packets to another host, etc.

FIG. 8 is another simplified flow diagram illustrating an example process for efficiently coordinating management of flows between an accelerator of an NVD and a remote programming data plane of another device, according to some embodiments. In process 800 of FIG. 8, an accelerator of a smartNIC transmits a packet to a remote programming data plane of a paired (and physically distinct) device. In some embodiments, the devices were previously paired in accordance with process 700. The remote programming data plane processes the packet and then transmits an instruction to the accelerator that is associated with processing the packet. In some embodiments, one or more operations of process 800 may be similar to as described in reference to FIG. 6.

At block 802, an accelerator of a smartNIC may receive a packet. In some embodiments, one or more operations of block 802 may be similar as described in reference to block 602 of FIG. 6. In some embodiments, the packet may be any suitable packet type, including, for example, a data packet or a control packet. In some embodiments, a data packet and/or control packet may be formatted according to industry standard, for example, according to the Open System Interconnection (OSI) Model. For example, the packet may be formatted to include an IP header, a TCP header, etc. In some embodiments, in the case where the packet is received via a network path that utilizes network virtualization, the packet may include a VLAN tag. In some embodiments, the packet may be received over any suitable network path. For example, the network path may utilize any one or more physical networks and/or virtual networks (e.g., overlaid on the physical network(s)). In some embodiments, a data packet may include payload data that corresponds to typical Internet traffic (e.g., requesting a web page, streaming a video, etc.). In some embodiments, a control packet may include control information (e.g., within the packet payload and/or header information) that is associated with processing packets and/or flows by the smartNIC and/or a programming data plane (e.g., a paired remote programming data plane or a local programming data plane). For example, the control packet may include flow expiry information (e.g. including flow timeout parameters), instructions for providing flow statistics, a log of flow statistics, a security list (e.g., indicating approved or disapproved flows, devices, etc.), instructions for forwarding or dropping a packet, instructions to log a packet, instructions for providing a particular quality of service (QoS) for a flow, etc. In some embodiments, the instructions may correspond to programming instructions that may be used to program the accelerator (e.g., storing one or more instructions to memory). In some embodiments, a single control packet may be used to transmit control information, whereby the control information is contained within a payload (and/or header) of the single control packet. In some embodiments, the payload may fit within an Ethernet jumbo frame. In some embodiments, a control packet may be transmitted within the context of a connection (e.g., a Transport Control Protocol connection), as described herein. For example, instead of control information being included within a jumbo frame, the control information may span a plurality of packets of a flow, whereby the packet is one of the packets of the flow. In some embodiments, where the packet corresponds to a control packet, the control packet may be received from a paired remote programming data plane (e.g., as described in reference to FIG. 7). In some embodiments, the control packet may be received from a local programming data plane. In some embodiments, where the packet corresponds to a data packet, the data packet may be received from any suitable sender device.

At block 804, the accelerator may determine that the packet necessitates further processing. In some embodiments, one or more operations of block 802 may be similar to as described in reference to block 604 of FIG. 6. For example, consider a case where the packet is a data packet. In this example, the accelerator may determine (e.g., based on referencing an accelerator cache) that the data packet is not associated with an approved flow. Accordingly, the accelerator may determine that the packet may be a candidate for rejection and necessitates further processing to determine if the packet should be forwarded. In some embodiments, a local programming data plane of the smartNIC may further process the data packet. For example, in one case, the accelerator transmits the data packet to the local programming data plane upon determining that the packet is not associated with an existing flow. The local programming data plane may then determine to contact a paired remote programming data plane to obtain further instructions, and then instructs the accelerator to contact the remote programming data plane.

At block 806, the accelerator may transmit the packet over a network path to a remote programming data plane of a remote device, whereby the remote programming data plane is paired with the accelerator. In some embodiments, one or more operations of block 806 may be similar to as described in reference to block 604 of FIG. 6. For example, continuing with the example above, the accelerator may forward the packet (e.g., the data packet) to the remote programming data plane that was previously paired with the accelerator (e.g., during process 700). In some embodiments, the accelerator may additionally (and/or alternatively) send a control packet to the remote programming data plane, which may include information about the data packet (e.g., header information, payload information, etc.), which may be operable for analysis by the remote programming data plane. In some embodiments, the network path may be similar to (e.g., the same as) the network path from which the packet was received, at block 802.

At block 808, the accelerator may receive from the remote programming data plane an instruction associated with processing the packet. For example, the instruction may be associated with processing one or more flows associated with the packet. In some embodiments, one or more operations of block 808 may be similar to as described in reference to block 606 of FIG. 6. In some embodiments, the instruction may be received via any suitable mechanism, as described herein (e.g., a single control packet that is independent of a connection, or, over a connection). In some embodiments, the instruction may be validated, for example, by decrypting a packet that contains the instruction. The validation process may validate that the instruction is a valid instruction from the paired remote programming data plane of the remote device. In some embodiments, the validation process may include any suitable procedure. For example, the accelerator (and/or the local programming data plane) may validate that the instruction is still applicable (e.g., not stale), given the current state of accelerator memory. In some embodiments, an instruction may correspond to any suitable one or more instructions. For example, the instruction may instruct the accelerator to drop the packet, log the packet, forward the packet to the intended destination, add a new cache entry for a newly approved flow that is associated with the packet, generate a statistics report for a flow associated with the packet, etc. In some embodiments, the instruction may be associated with processing other flows that are independent of the packet.

At block 810, the accelerator may forward the packet based on the instruction. For example, the accelerator may process instruction data corresponding to the instruction based in part on determining (e.g., validating) that the instruction was received from the remote programming data plane of the remote device (e.g., over the network path), which is paired with the accelerator. In some embodiments, utilizing the example above, suppose that the instruction instructs the accelerator to forward and log the data packet. Accordingly, the accelerator may forward the data packet to the intended destination, and then log the packet to a log (e.g., which may be maintained by the accelerator). In some embodiments, the accelerator may optionally coordinate processing of the instruction with a local programming data plane of the smartNIC. Although the example above related to forwarding the packet based on the instruction, embodiments, should not be construed to be so limited. The accelerator (and/or the local programming data plane) may process instruction data corresponding to the instruction in any suitable way, including, for example, programming the accelerator memory with programming instructions to handle future packets, forwarding a portion of future packets received by the accelerator to the remote programming data plane, etc.

FIG. 9 is another simplified flow diagram illustrating an example process for efficiently coordinating management of flows between an accelerator of an NVD and a remote programming data plane of another device, according to some embodiments. In some embodiments, process 900 of FIG. 9 depicts a process in which a remote programming data plane determines an instruction for programming a remotely paired accelerator. In some embodiments, process 900 (e.g., performed by a remote programming data plane) is complementary to process 700 and/or 800 (e.g., performed by an accelerator).

At block 902, a remote programming data plane of a remote device may determine that an accelerator of a smartNIC is paired with the remote programming data plane. In some embodiments, one or more operations of block 902 may be similar to as described in reference to FIG. 5. For example, suppose that the remote device is a computer server that is connected to the smartNIC via a virtual network path. The remote device may include the remote programming data plane (e.g., implemented via a combination of hardware and software). For example, the remote programming data plane may execute as a service, whereby the service utilizes one or more processors of the server. In some embodiments, as described herein, the service may coordinate pairing with the accelerator via any suitable procedure (e.g., utilizing cryptographic technologies, a handshake protocol, etc.). For example, the remote programming data plane may initiate a request to transmit to the accelerator, requesting that the accelerator be paired (and/or re-paired, as the case may be) with the remote programming data plane. In another example, the accelerator (and/or a third-party service) may transmit a request to the remote programming data plane, requesting that the remote programming data plane register a pairing with the particular accelerator of the smartNIC. In any case, the remote programming data plane may store registration data indicating the new pairing between the accelerator and the remote programming data plane. In some embodiments, a connection may (or may not) be associated with the pairing. For example a TCP connection may be established, which may be used for future communication between the paired devices. In cases where a connection may not be established, the devices may communicate information (e.g., requests for instructions, instructions, packet data, etc.) via a single packet (e.g., a single control packet and/or data packet).

At block 904, the remote programming data plane receives a packet from the accelerator over a network path. In some embodiments, one or more operations of block 904 may be similar to as described in reference to block 604 of FIG. 6. For example, the remote programming data plane may receive a data packet from the accelerator. In this example, the data packet may be associated with a request for further instructions. In some embodiments, a control packet may encapsulate a data packet, for example, whereby the control packet includes a control packet header. The control packet header may include information associated with the data packet (e.g., a request for instructions, etc.). Accordingly, in some embodiments, the packet may correspond to a control packet, which may include a data packet. In some embodiments, a control packet may not include a data packet. For example, the control packet payload may include log information or other suitable information that was previously requested by the remote programming data plane related to packet processing by the smartNIC.

At block 906, the remote programming data plane determines an instruction for processing one or more flows based on the packet. For example, as described herein, the remote programming data plane may analyze the packet (e.g., in this example, a data packet) and determine that the data packet was transmitted by an entity (e.g., a source device, client application, etc.) that is an approved entity that is listed within a security list that is maintained by the remote programming data plane. In some embodiments, the security list may be regularly updated (e.g., more frequently than a security list maintained by the smartNIC) based in part on the remote programming data plane having greater contextual visibility as to the surrounding environment. This contextual visibility may be associated with any suitable information, including, but not limited to, updated customer profile information, updated network conditions, current availability of resources (e.g., other remote programming data planes, other smartNICs, host devices, etc.) within the virtual network, etc. It should be understood that the instruction may be determined based on any suitable information available to the remote programming data plane.

At block 908, the remote programming data plane may transmit the instruction to the accelerator over the network path. In some embodiments, one or more operations of block 908 may be similar to as described in reference to block 606. For example, the instruction may be included within a single control packet that is transmitted via the virtual network to the accelerator. In this example, the accelerator may then forward the data packet to the intended destination based on the instruction. In another example, the accelerator may program memory with programming instructions based on the instruction.

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

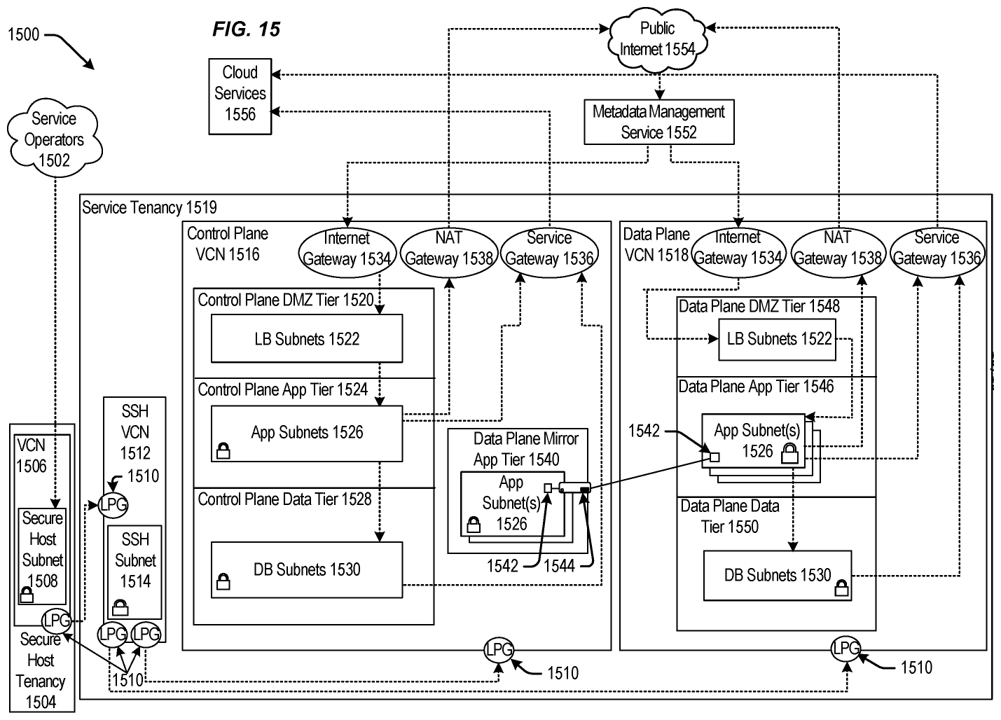

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 15, 16, 17, and 18 (see references 1516, 1616, 1716, and 1816) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

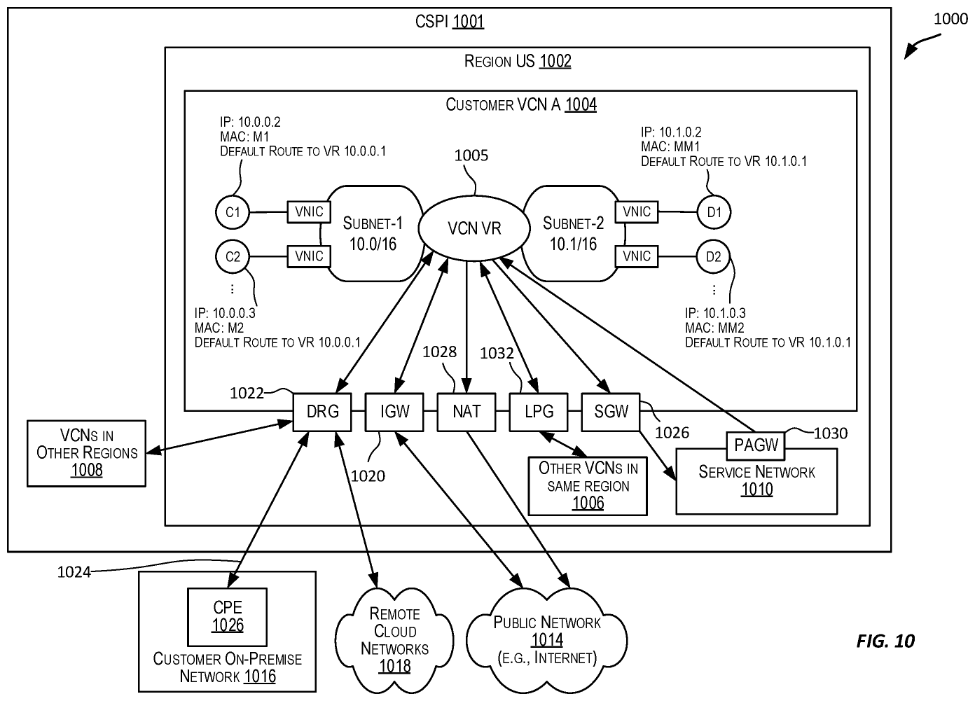

Various different architectures for implementing cloud-based service using CSPI are depicted in FIGS. 10, 11, 12, 13, 14, 15, 16, 17, and 19, and are described below. FIG. 10 is a high level diagram of a distributed environment 1000 showing an overlay or customer VCN hosted by CSPI according to certain embodiments. The distributed environment depicted in FIG. 10 includes multiple components in the overlay network. Distributed environment 1000 depicted in FIG. 10 is merely an example and is not intended to unduly limit the scope of claimed embodiments. Many variations, alternatives, and modifications are possible. For example, in some implementations, the distributed environment depicted in FIG. 10 may have more or fewer systems or components than those shown in FIG. 1, may combine two or more systems, or may have a different configuration or arrangement of systems.

As shown in the example depicted in FIG. 10, distributed environment 1000 comprises CSPI 1001 that provides services and resources that customers can subscribe to and use to build their virtual cloud networks (VCNs). In certain embodiments, CSPI 1001 offers IaaS services to subscribing customers. The data centers within CSPI 1001 may be organized into one or more regions. One example region “Region US” 1002 is shown in FIG. 10. A customer has configured a customer VCN 1004 for region 1002. The customer may deploy various compute instances on VCN 1004, where the compute instances may include virtual machines or bare metal instances. Examples of instances include applications, database, load balancers, and the like.

In the embodiment depicted in FIG. 10, customer VCN 1004 comprises two subnets, namely, “Subnet-1” and “Subnet-2”, each subnet with its own CIDR IP address range. In FIG. 10, the overlay IP address range for Subnet-1 is 10.0/16 and the address range for Subnet-2 is 10.1/16. A VCN Virtual Router 1005 represents a logical gateway for the VCN that enables communications between subnets of the VCN 1004, and with other endpoints outside the VCN. VCN VR 1005 is configured to route traffic between VNICs in VCN 1004 and gateways associated with VCN 1004. VCN VR 1005 provides a port for each subnet of VCN 1004. For example, VR 1005 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 1001. A compute instance participates in a subnet via a VNIC associated with the compute instance. For example, as shown in FIG. 10, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 10, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 1005 using IP address 10.0.0.1, which is the IP address for a port of VCN VR 1005 for Subnet-1.

Subnet-2 can have multiple compute instances deployed on it, including virtual machine instances and/or bare metal instances. For example, as shown in FIG. 10, compute instances D1 and D2 are part of Subnet-2 via VNICs associated with the respective compute instances. In the embodiment depicted in FIG. 10, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 1005 using IP address 10.1.0.1, which is the IP address for a port of VCN VR 1005 for Subnet-2.

VCN A 1004 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 1004 can communicate with various different endpoints. These endpoints may include endpoints that are hosted by CSPI 1100 and endpoints outside CSPI 1100. Endpoints that are hosted by CSPI 1001 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 1006 or 1010, communications between a compute instance in Subnet-1 and an endpoint in service network 1010 in the same region); or an endpoint in a VCN in a different region (e.g., communications between a compute instance in Subnet-1 and an endpoint in a VCN in a different region 1008). A compute instance in a subnet hosted by CSPI 1001 may also communicate with endpoints that are not hosted by CSPI 1001 (i.e., are outside CSPI 1001). These outside endpoints include endpoints in the customer's on-premise network 1016, endpoints within other remote cloud hosted networks 1018, public endpoints 1014 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 10 wants to send a packet to compute instance D1 in Subnet-2, the packet is first processed by the VNIC associated with compute instance C1. The VNIC associated with compute instance C1 is configured to route the packet to the VCN VR 1005 using default route or port 10.0.0.1 of the VCN VR. VCN VR 1005 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 1004 to an endpoint that is outside VCN 1004, the communication is facilitated by the VNIC associated with the source compute instance, VCN VR 1005, and gateways associated with VCN 1004. One or more types of gateways may be associated with VCN 1004. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 1004. The packet may be first processed by the VNIC associated with source compute instance C1. The VNIC processing determines that the destination for the packet is outside the Subnet-1 of C1. The VNIC associated with C1 may forward the packet to VCN VR 1005 for VCN 1004. VCN VR 1005 then processes the packet and as part of the processing, based upon the destination for the packet, determines a particular gateway associated with VCN 1004 as the next hop for the packet. VCN VR 1005 may then forward the packet to the particular identified gateway. For example, if the destination is an endpoint within the customer's on-premise network, then the packet may be forwarded by VCN VR 1005 to Dynamic Routing Gateway (DRG) gateway 1022 configured for VCN 1004. The packet may then be forwarded from the gateway to a next hop to facilitate communication of the packet to it final intended destination.

Various different types of gateways may be configured for a VCN. Examples of gateways that may be configured for a VCN are depicted in FIG. 10 and described below. Examples of gateways associated with a VCN are also depicted in FIGS. 15, 16, 17, and 18 (for example, gateways referenced by reference numbers 1534, 1536, 1538, 1634, 1636, 1638, 1734, 1736, 1738, 1834, 1836, and 1838) and described below. As shown in the embodiment depicted in FIG. 10, a Dynamic Routing Gateway (DRG) 1022 may be added to or be associated with customer VCN 1004 and provides a path for private network traffic communication between customer VCN 1004 and another endpoint, where the another endpoint can be the customer's on-premise network 1016, a VCN 1008 in a different region of CSPI 1001, or other remote cloud networks 1018 not hosted by CSPI 1001. Customer on-premise network 1016 may be a customer network or a customer data center built using the customer's resources. Access to customer on-premise network 1016 is generally very restricted. For a customer that has both a customer on-premise network 1016 and one or more VCNs 1004 deployed or hosted in the cloud by CSPI 1001, the customer may want their on-premise network 1016 and their cloud-based VCN 1004 to be able to communicate with each other. This enables a customer to build an extended hybrid environment encompassing the customer's VCN 1004 hosted by CSPI 1001 and their on-premises network 1016. DRG 1022 enables this communication. To enable such communications, a communication channel 1024 is set up where one endpoint of the channel is in customer on-premise network 1016 and the other endpoint is in CSPI 1001 and connected to customer VCN 1004. Communication channel 1024 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 1016 that forms one end point for communication channel 1024 is referred to as the customer premise equipment (CPE), such as CPE 1026 depicted in FIG. 10. On the CSPI 1001 side, the endpoint may be a host machine executing DRG 1022.

In certain embodiments, a Remote Peering Connection (RPC) can be added to a DRG, which allows a customer to peer one VCN with another VCN in a different region. Using such an RPC, customer VCN 1004 can use DRG 1022 to connect with a VCN 1008 in another region. DRG 1022 may also be used to communicate with other remote cloud networks 1018, not hosted by CSPI 1001 such as a Microsoft Azure cloud, Amazon AWS cloud, and others.

As shown in FIG. 10, an Internet Gateway (IGW) 1020 may be configured for customer VCN 1004 the enables a compute instance on VCN 1004 to communicate with public endpoints 1014 accessible over a public network such as the Internet. IGW 1020 is a gateway that connects a VCN to a public network such as the Internet. IGW 1020 enables a public subnet (where the resources in the public subnet have public overlay IP addresses) within a VCN, such as VCN 1004, direct access to public endpoints 1012 on a public network 1014 such as the Internet. Using IGW 1020, connections can be initiated from a subnet within VCN 1004 or from the Internet.

A Network Address Translation (NAT) gateway 1028 can be configured for customer's VCN 1004 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 1004, with private access to public endpoints on the Internet. In NAT gateways, connections can be initiated only from the private subnet to the public Internet and not from the Internet to the private subnet.

In certain embodiments, a Service Gateway (SGW) 1026 can be configured for customer VCN 1004 and provides a path for private network traffic between VCN 1004 and supported services endpoints in a service network 1010. In certain embodiments, service network 1010 may be provided by the CSP and may provide various services. An example of such a service network is Oracle's Services Network, which provides various services that can be used by customers. For example, a compute instance (e.g., a database system) in a private subnet of customer VCN 1004 can back up data to a service endpoint (e.g., Object Storage) without needing public IP addresses or access to the Internet. In certain embodiments, a VCN can have only one SGW, and connections can only be initiated from a subnet within the VCN and not from service network 1010. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 1026 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 1032 is a gateway that can be added to customer VCN 1004 and enables VCN 1004 to peer with another VCN in the same region. Peering means that the VCNs communicate using private IP addresses, without the traffic traversing a public network such as the Internet or without routing the traffic through the customer's on-premises network 1016. In preferred embodiments, a VCN has a separate LPG for each peering it establishes. Local Peering or VCN Peering is a common practice used to establish network connectivity between different applications or infrastructure management functions.

Service providers, such as providers of services in service network 1010, may provide access to services using different access models. According to a public access model, services may be exposed as public endpoints that are publicly accessible by compute instance in a customer VCN via a public network such as the Internet and or may be privately accessible via SGW 1026. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 1030 is a gateway resource that can be attached to a service provider VCN (e.g., a VCN in service network 1010) that acts as an ingress/egress point for all traffic from/to customer subnet private endpoints. PAGW 1030 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 1030 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 1032 and the PE in the customer's VCN.

A customer can control routing in a VCN at the subnet level, so the customer can specify which subnets in the customer's VCN, such as VCN 1004, use each gateway. A VCN's route tables are used to decide if traffic is allowed out of a VCN through a particular gateway. For example, in a particular instance, a route table for a public subnet within customer VCN 1004 may send non-local traffic through IGW 1020. The route table for a private subnet within the same customer VCN 1004 may send traffic destined for CSP services through SGW 1026. All remaining traffic may be sent via the NAT gateway 1028. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 1004) can be categorized as public access, private access, or dedicated access. Public access refers to an access model where a public IP address or a NAT is used to access a public endpoint. Private access enables customer workloads in VCN 1004 with private IP addresses (e.g., resources in a private subnet) to access services without traversing a public network such as the Internet. In certain embodiments, CSPI 1001 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

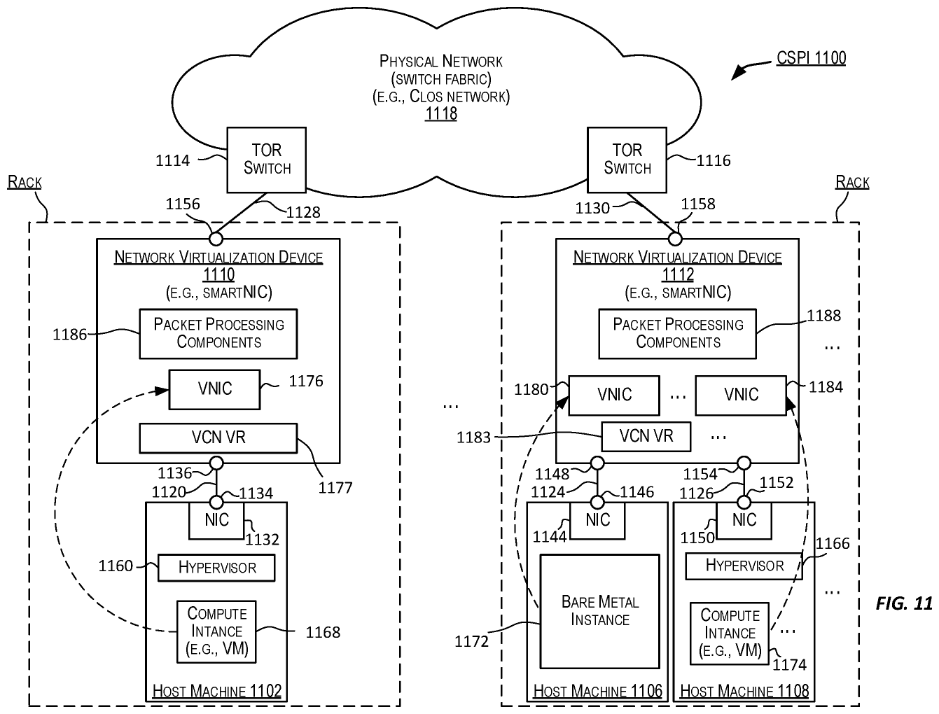

FIG. 10 and the accompanying description above describes various virtualized components in an example virtual network. As described above, the virtual network is built on the underlying physical or substrate network. FIG. 11 depicts a simplified architectural diagram of the physical components in the physical network within CSPI 1100 that provide the underlay for the virtual network according to certain embodiments. As shown, CSPI 1100 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 1100 are provisioned for the customer. Customers can then build their own cloud-based (i.e., CSPI-hosted) customizable and private virtual networks using physical compute, memory, and networking resources provided by CSPI 1100. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 1100 provides infrastructure and a set of complementary cloud services that enable customers to build and run a wide range of applications and services in a highly available hosted environment.

In the example embodiment depicted in FIG. 11, the physical components of CSPI 1100 include one or more physical host machines or physical servers (e.g., 1102, 1106, 1108), network virtualization devices (NVDs) (e.g., 1110, 1112), top-of-rack (TOR) switches (e.g., 1114, 1116), and a physical network (e.g., 1118), and switches in physical network 1118. The physical host machines or servers may host and execute various compute instances that participate in one or more subnets of a VCN. The compute instances may include virtual machine instances, and bare metal instances. For example, the various compute instances depicted in FIG. 10 may be hosted by the physical host machines depicted in FIG. 11. The virtual machine compute instances in a VCN may be executed by one host machine or by multiple different host machines. The physical host machines may also host virtual host machines, container-based hosts or functions, and the like. The VNICs and VCN VR depicted in FIG. 10 may be executed by the NVDs depicted in FIG. 11. The gateways depicted in FIG. 10 may be executed by the host machines and/or by the NVDs depicted in FIG. 11.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 11, host machines 1102 and 1108 execute hypervisors 1160 and 1166, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 11, hypervisor 1160 may sit on top of the OS of host machine 1102 and enables the computing resources (e.g., processing, memory, and networking resources) of host machine 1102 to be shared between compute instances (e.g., virtual machines) executed by host machine 1102. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 11 may have the same or different types of hypervisors.

A compute instance can be a virtual machine instance or a bare metal instance. In FIG. 11, compute instances 1168 on host machine 1102 and 1174 on host machine 1108 are examples of virtual machine instances. Host machine 1106 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 11, host machine 1102 executes a virtual machine compute instance 1168 that is associated with VNIC 1176, and VNIC 1176 is executed by NVD 1110 connected to host machine 1102. As another example, bare metal instance 1172 hosted by host machine 1106 is associated with VNIC 1180 that is executed by NVD 1112 connected to host machine 1106. As yet another example, VNIC 1184 is associated with compute instance 1174 executed by host machine 1108, and VNIC 1184 is executed by NVD 1112 connected to host machine 1108.

For compute instances hosted by a host machine, an NVD connected to that host machine also executes VCN VRs corresponding to VCNs of which the compute instances are members. For example, in the embodiment depicted in FIG. 11, NVD 1110 executes VCN VR 1177 corresponding to the VCN of which compute instance 1168 is a member. NVD 1112 may also execute one or more VCN VRs 1183 corresponding to VCNs corresponding to the compute instances hosted by host machines 1106 and 1108.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 11, host machine 1102 is connected to NVD 1110 using link 1120 that extends between a port 1134 provided by a NIC 1132 of host machine 1102 and between a port 1136 of NVD 1110. Host machine 1106 is connected to NVD 1112 using link 1124 that extends between a port 1146 provided by a NIC 1144 of host machine 1106 and between a port 1148 of NVD 1112. Host machine 1108 is connected to NVD 1112 using link 1126 that extends between a port 1152 provided by a NIC 1150 of host machine 1108 and between a port 1154 of NVD 1112.

The NVDs are in turn connected via communication links to top-of-the-rack (TOR) switches, which are connected to physical network 1118 (also referred to as the switch fabric). In certain embodiments, the links between a host machine and an NVD, and between an NVD and a TOR switch are Ethernet links. For example, in FIG. 11, NVDs 1110 and 1112 are connected to TOR switches 1114 and 1116, respectively, using links 1128 and 1130. In certain embodiments, the links 1120, 1124, 1126, 1128, and 1130 are Ethernet links. The collection of host machines and NVDs that are connected to a TOR is sometimes referred to as a rack.

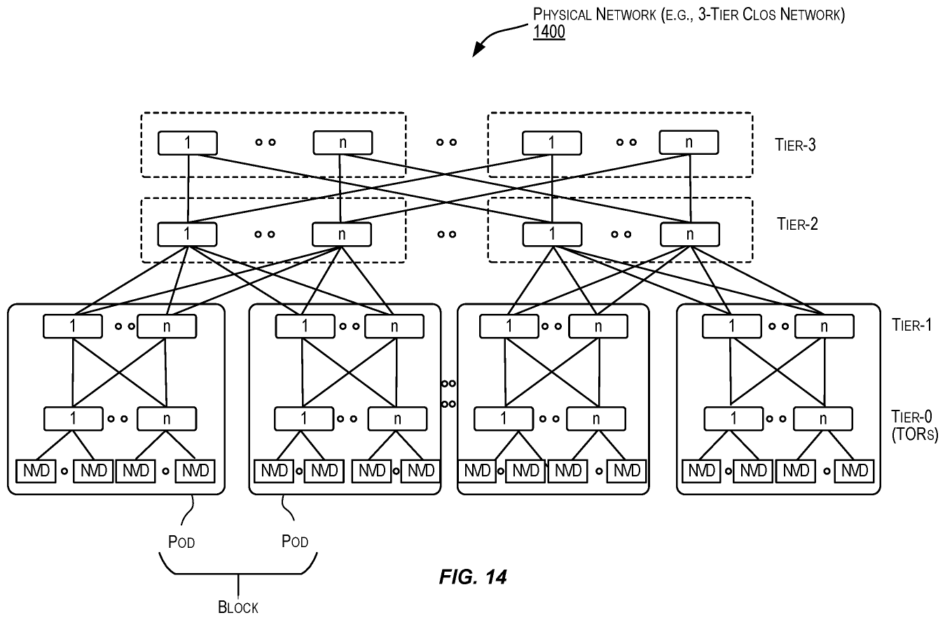

Physical network 1118 provides a communication fabric that enables TOR switches to communicate with each other. Physical network 1118 can be a multi-tiered network. In certain implementations, physical network 1118 is a multi-tiered Clos network of switches, with TOR switches 1114 and 1116 representing the leaf level nodes of the multi-tiered and multi-node physical switching network 1118. Different Clos network configurations are possible including but not limited to a 2-tier network, a 3-tier network, a 4-tier network, a 5-tier network, and in general a “n”-tiered network. An example of a Clos network is depicted in FIG. 14 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 11, host machine 1102 is connected to NVD 1110 via NIC 1132 of host machine 1102. In a many-to-one configuration, multiple host machines are connected to one NVD. For example, in FIG. 11, host machines 1106 and 1108 are connected to the same NVD 1112 via NICs 1144 and 1150, respectively.

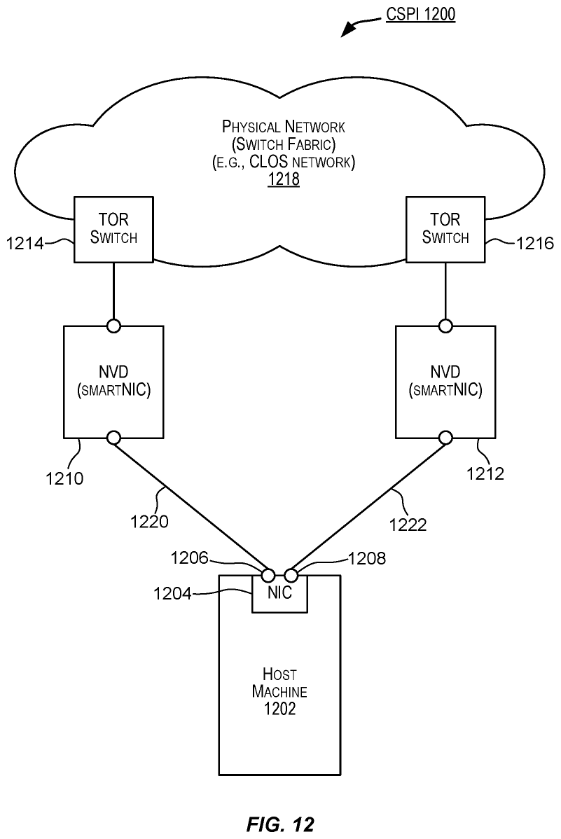

In a one-to-many configuration, one host machine is connected to multiple NVDs. FIG. 12 shows an example within CSPI 1200 where a host machine is connected to multiple NVDs. As shown in FIG. 12, host machine 1202 comprises a network interface card (NIC) 1204 that includes multiple ports 1206 and 1208. Host machine 1200 is connected to a first NVD 1210 via port 1206 and link 1220, and connected to a second NVD 1212 via port 1208 and link 1222. Ports 1206 and 1208 may be Ethernet ports and the links 1220 and 1222 between host machine 1202 and NVDs 1210 and 1212 may be Ethernet links. NVD 1210 is in turn connected to a first TOR switch 1214 and NVD 1212 is connected to a second TOR switch 1216. The links between NVDs 1210 and 1212, and TOR switches 1214 and 1216 may be Ethernet links. TOR switches 1214 and 1216 represent the Tier-0 switching devices in multi-tiered physical network 1218.

The arrangement depicted in FIG. 12 provides two separate physical network paths to and from physical switch network 1218 to host machine 1202: a first path traversing TOR switch 1214 to NVD 1210 to host machine 1202, and a second path traversing TOR switch 1216 to NVD 1212 to host machine 1202. The separate paths provide for enhanced availability (referred to as high availability) of host machine 1202. If there are problems in one of the paths (e.g., a link in one of the paths goes down) or devices (e.g., a particular NVD is not functioning), then the other path may be used for communications to/from host machine 1202.

In the configuration depicted in FIG. 12, the host machine is connected to two different NVDs using two different ports provided by a NIC of the host machine. In other embodiments, a host machine may include multiple NICs that enable connectivity of the host machine to multiple NVDs.

Referring back to FIG. 11, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 11, the NVDs 1110 and 1112 may be implemented as smartNICs that are connected to host machines 1102, and host machines 1106 and 1108, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 1100. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 11, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 11 include port 1136 on NVD 1110, and ports 1148 and 1154 on NVD 1112. A network-facing port of an NVD is a port that is used to connect the NVD to a TOR switch. Examples of network-facing ports in FIG. 11 include port 1156 on NVD 1110, and port 1158 on NVD 1112. As shown in FIG. 11, NVD 1110 is connected to TOR switch 1114 using link 1128 that extends from port 1156 of NVD 1110 to the TOR switch 1114. Likewise, NVD 1112 is connected to TOR switch 1116 using link 1130 that extends from port 1158 of NVD 1112 to the TOR switch 1116.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 15, 16, 17, and 18 (see references 1516, 1616, 1716, and 1816) and described below. Examples of a VCN Data Plane are depicted in FIGS. 15, 16, 17, and 18 (see references 1518, 1618, 1718, and 1818) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 11, NVD 1110 executes the functionality for VNIC 1176 that is associated with compute instance 1168 hosted by host machine 1102 connected to NVD 1110. As another example, NVD 1112 executes VNIC 1180 that is associated with bare metal compute instance 1172 hosted by host machine 1106, and executes VNIC 1184 that is associated with compute instance 1174 hosted by host machine 1108. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 11, NVD 1110 executes VCN VR 1177 corresponding to the VCN to which compute instance 1168 belongs. NVD 1112 executes one or more VCN VRs 1183 corresponding to one or more VCNs to which compute instances hosted by host machines 1106 and 1108 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 11. For example, NVD 1110 comprises packet processing components 1186 and NVD 1112 comprises packet processing components 1188. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 10 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 10 may be executed or hosted by one or more of the physical components depicted in FIG. 11. For example, the compute instances in a VCN may be executed or hosted by one or more host machines depicted in FIG. 11. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 11, a packet originating from compute instance 1168 may be communicated from host machine 1102 to NVD 1110 over link 1120 (using NIC 1132). On NVD 1110, VNIC 1176 is invoked since it is the VNIC associated with source compute instance 1168. VNIC 1176 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 1100 and endpoints outside CSPI 1100. Endpoints hosted by CSPI 1100 may include instances in the same VCN or other VCNs, which may be the customer's VCNs, or VCNs not belonging to the customer. Communications between endpoints hosted by CSPI 1100 may be performed over physical network 1118. A compute instance may also communicate with endpoints that are not hosted by CSPI 1100, or are outside CSPI 1100. Examples of these endpoints include endpoints within a customer's on-premise network or data center, or public endpoints accessible over a public network such as the Internet. Communications with endpoints outside CSPI 1100 may be performed over public networks (e.g., the Internet) (not shown in FIG. 11) or private networks (not shown in FIG. 11) using various communication protocols.

The architecture of CSPI 1100 depicted in FIG. 11 is merely an example and is not intended to be limiting. Variations, alternatives, and modifications are possible in alternative embodiments. For example, in some implementations, CSPI 1100 may have more or fewer systems or components than those shown in FIG. 11, may combine two or more systems, or may have a different configuration or arrangement of systems. The systems, subsystems, and other components depicted in FIG. 11 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

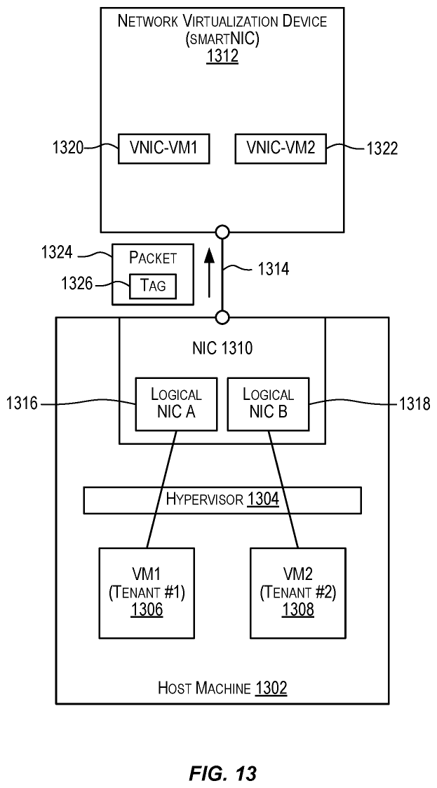

FIG. 13 depicts connectivity between a host machine and an NVD for providing I/O virtualization for supporting multitenancy according to certain embodiments. As depicted in FIG. 13, host machine 1302 executes a hypervisor 1304 that provides a virtualized environment. Host machine 1302 executes two virtual machine instances, VM1 1306 belonging to customer/tenant #1 and VM2 1308 belonging to customer/tenant #2. Host machine 1302 comprises a physical NIC 1310 that is connected to an NVD 1312 via link 1314. Each of the compute instances is attached to a VNIC that is executed by NVD 1312. In the embodiment in FIG. 13, VM1 1306 is attached to VNIC-VM1 1320 and VM2 1308 is attached to VNIC-VM2 1322.

As shown in FIG. 13, NIC 1310 comprises two logical NICs, logical NIC A 1316 and logical NIC B 1318. Each virtual machine is attached to and configured to work with its own logical NIC. For example, VM1 1306 is attached to logical NIC A 1316 and VM2 1308 is attached to logical NIC B 1318. Even though host machine 1302 comprises only one physical NIC 1310 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 1316 for Tenant #1 and a separate VLAN ID is assigned to logical NIC B 1318 for Tenant #2. When a packet is communicated from VM1 1306, a tag assigned to Tenant #1 is attached to the packet by the hypervisor and the packet is then communicated from host machine 1302 to NVD 1312 over link 1314. In a similar manner, when a packet is communicated from VM2 1308, a tag assigned to Tenant #2 is attached to the packet by the hypervisor and the packet is then communicated from host machine 1302 to NVD 1312 over link 1314. Accordingly, a packet 1324 communicated from host machine 1302 to NVD 1312 has an associated tag 1326 that identifies a specific tenant and associated VM. On the NVD, for a packet 1324 received from host machine 1302, the tag 1326 associated with the packet is used to determine whether the packet is to be processed by VNIC-VM1 1320 or by VNIC-VM2 1322. The packet is then processed by the corresponding VNIC. The configuration depicted in FIG. 13 enables each tenant's compute instance to believe that they own their own host machine and NIC. The setup depicted in FIG. 13 provides for I/O virtualization for supporting multi-tenancy.

FIG. 14 depicts a simplified block diagram of a physical network 1400 according to certain embodiments. The embodiment depicted in FIG. 14 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 14 is a 3-tiered network comprising tiers 1, 2, and 3. The TOR switches 1404 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 14, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1400 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION][.FUTURE USE].<UNIQUE ID>
   where,
   ocid1: The literal string indicating the version of the CID;
   resource type: The type of resource (for example, instance, volume, VCN, subnet, user, group, and so on);
   realm: The realm the resource is in. Example values are “c1” for the commercial realm, “c2” for the Government Cloud realm, or “c3” for the Federal Government Cloud realm, etc. Each realm may have its own domain name;
   region: The region the resource is in. If the region is not applicable to the resource, this part might be blank;
   future use: Reserved for future use.
   unique ID: The unique portion of the ID. The format may vary depending on the type of resource or service.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 15 is a block diagram 1500 illustrating an example pattern of an IaaS architecture, according to at least one embodiment. Service operators 1502 can be communicatively coupled to a secure host tenancy 1504 that can include a virtual cloud network (VCN) 1506 and a secure host subnet 1508. In some examples, the service operators 1502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1506 and/or the Internet.

The VCN 1506 can include a local peering gateway (LPG) 1510 that can be communicatively coupled to a secure shell (SSH) VCN 1512 via an LPG 1510 contained in the SSH VCN 1512. The SSH VCN 1512 can include an SSH subnet 1514, and the SSH VCN 1512 can be communicatively coupled to a control plane VCN 1516 via the LPG 1510 contained in the control plane VCN 1516. Also, the SSH VCN 1512 can be communicatively coupled to a data plane VCN 1518 via an LPG 1510. The control plane VCN 1516 and the data plane VCN 1518 can be contained in a service tenancy 1519 that can be owned and/or operated by the IaaS provider.

The control plane VCN 1516 can include a control plane demilitarized zone (DMZ) tier 1520 that acts as a perimeter network (e.g., portions of a corporate network between the corporate intranet and external networks). The DMZ-based servers may have restricted responsibilities and help keep breaches contained. Additionally, the DMZ tier 1520 can include one or more load balancer (LB) subnet(s) 1522, a control plane app tier 1524 that can include app subnet(s) 1526, a control plane data tier 1528 that can include database (DB) subnet(s) 1530 (e.g., frontend DB subnet(s) and/or backend DB subnet(s)). The LB subnet(s) 1522 contained in the control plane DMZ tier 1520 can be communicatively coupled to the app subnet(s) 1526 contained in the control plane app tier 1524 and an Internet gateway 1534 that can be contained in the control plane VCN 1516, and the app subnet(s) 1526 can be communicatively coupled to the DB subnet(s) 1530 contained in the control plane data tier 1528 and a service gateway 1536 and a network address translation (NAT) gateway 1538. The control plane VCN 1516 can include the service gateway 1536 and the NAT gateway 1538.

The control plane VCN 1516 can include a data plane mirror app tier 1540 that can include app subnet(s) 1526. The app subnet(s) 1526 contained in the data plane mirror app tier 1540 can include a virtual network interface controller (VNIC) 1542 that can execute a compute instance 1544. The compute instance 1544 can communicatively couple the app subnet(s) 1526 of the data plane mirror app tier 1540 to app subnet(s) 1526 that can be contained in a data plane app tier 1546.

The data plane VCN 1518 can include the data plane app tier 1546, a data plane DMZ tier 1548, and a data plane data tier 1550. The data plane DMZ tier 1548 can include LB subnet(s) 1522 that can be communicatively coupled to the app subnet(s) 1526 of the data plane app tier 1546 and the Internet gateway 1534 of the data plane VCN 1518. The app subnet(s) 1526 can be communicatively coupled to the service gateway 1536 of the data plane VCN 1518 and the NAT gateway 1538 of the data plane VCN 1518. The data plane data tier 1550 can also include the DB subnet(s) 1530 that can be communicatively coupled to the app subnet(s) 1526 of the data plane app tier 1546.

The Internet gateway 1534 of the control plane VCN 1516 and of the data plane VCN 1518 can be communicatively coupled to a metadata management service 1552 that can be communicatively coupled to public Internet 1554. Public Internet 1554 can be communicatively coupled to the NAT gateway 1538 of the control plane VCN 1516 and of the data plane VCN 1518. The service gateway 1536 of the control plane VCN 1516 and of the data plane VCN 1518 can be communicatively couple to cloud services 1556.

In some examples, the service gateway 1536 of the control plane VCN 1516 or of the data plane VCN 1518 can make application programming interface (API) calls to cloud services 1556 without going through public Internet 1554. The API calls to cloud services 1556 from the service gateway 1536 can be one-way: the service gateway 1536 can make API calls to cloud services 1556, and cloud services 1556 can send requested data to the service gateway 1536. But, cloud services 1556 may not initiate API calls to the service gateway 1536.

In some examples, the secure host tenancy 1504 can be directly connected to the service tenancy 1519, which may be otherwise isolated. The secure host subnet 1508 can communicate with the SSH subnet 1514 through an LPG 1510 that may enable two-way communication over an otherwise isolated system. Connecting the secure host subnet 1508 to the SSH subnet 1514 may give the secure host subnet 1508 access to other entities within the service tenancy 1519.

The control plane VCN 1516 may allow users of the service tenancy 1519 to set up or otherwise provision desired resources. Desired resources provisioned in the control plane VCN 1516 may be deployed or otherwise used in the data plane VCN 1518. In some examples, the control plane VCN 1516 can be isolated from the data plane VCN 1518, and the data plane mirror app tier 1540 of the control plane VCN 1516 can communicate with the data plane app tier 1546 of the data plane VCN 1518 via VNICs 1542 that can be contained in the data plane mirror app tier 1540 and the data plane app tier 1546.

In some examples, users of the system, or customers, can make requests, for example create, read, update, or delete (CRUD) operations, through public Internet 1554 that can communicate the requests to the metadata management service 1552. The metadata management service 1552 can communicate the request to the control plane VCN 1516 through the Internet gateway 1534. The request can be received by the LB subnet(s) 1522 contained in the control plane DMZ tier 1520. The LB subnet(s) 1522 may determine that the request is valid, and in response to this determination, the LB subnet(s) 1522 can transmit the request to app subnet(s) 1526 contained in the control plane app tier 1524. If the request is validated and requires a call to public Internet 1554, the call to public Internet 1554 may be transmitted to the NAT gateway 1538 that can make the call to public Internet 1554. Memory that may be desired to be stored by the request can be stored in the DB subnet(s) 1530.

In some examples, the data plane mirror app tier 1540 can facilitate direct communication between the control plane VCN 1516 and the data plane VCN 1518. For example, changes, updates, or other suitable modifications to configuration may be desired to be applied to the resources contained in the data plane VCN 1518. Via a VNIC 1542, the control plane VCN 1516 can directly communicate with, and can thereby execute the changes, updates, or other suitable modifications to configuration to, resources contained in the data plane VCN 1518.

In some embodiments, the control plane VCN 1516 and the data plane VCN 1518 can be contained in the service tenancy 1519. In this case, the user, or the customer, of the system may not own or operate either the control plane VCN 1516 or the data plane VCN 1518. Instead, the IaaS provider may own or operate the control plane VCN 1516 and the data plane VCN 1518, both of which may be contained in the service tenancy 1519. This embodiment can enable isolation of networks that may prevent users or customers from interacting with other users', or other customers', resources. Also, this embodiment may allow users or customers of the system to store databases privately without needing to rely on public Internet 1554, which may not have a desired level of threat prevention, for storage.

In other embodiments, the LB subnet(s) 1522 contained in the control plane VCN 1516 can be configured to receive a signal from the service gateway 1536. In this embodiment, the control plane VCN 1516 and the data plane VCN 1518 may be configured to be called by a customer of the IaaS provider without calling public Internet 1554. Customers of the IaaS provider may desire this embodiment since database(s) that the customers use may be controlled by the IaaS provider and may be stored on the service tenancy 1519, which may be isolated from public Internet 1554.

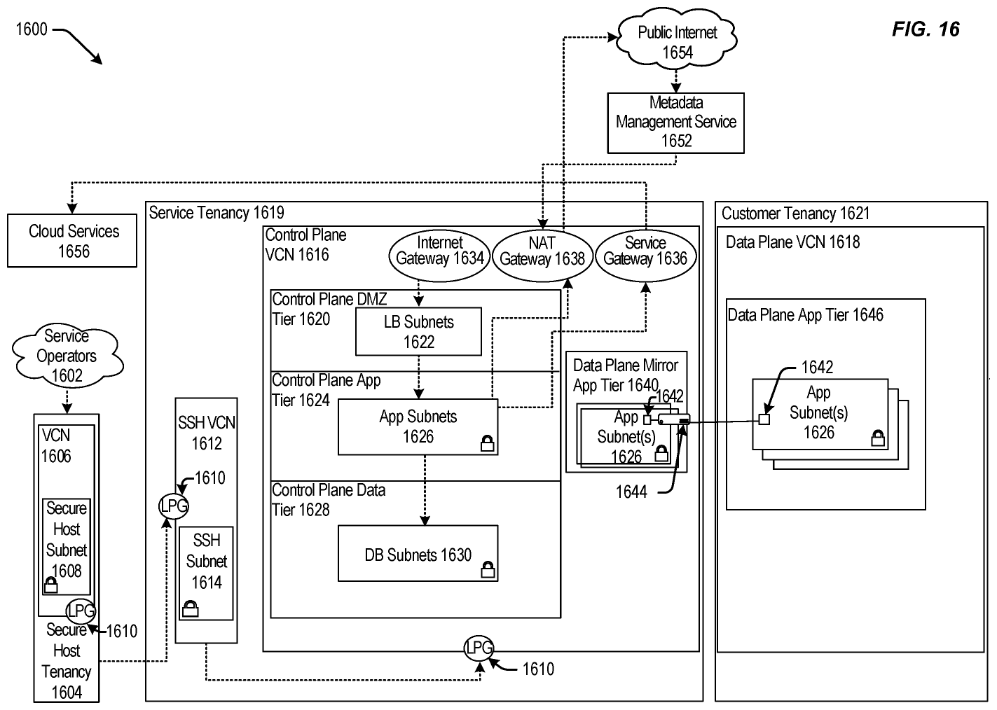

FIG. 16 is a block diagram 1600 illustrating another example pattern of an IaaS architecture, according to at least one embodiment. Service operators 1602 (e.g. service operators 1502 of FIG. 15) can be communicatively coupled to a secure host tenancy 1604 (e.g. the secure host tenancy 1504 of FIG. 15) that can include a virtual cloud network (VCN) 1606 (e.g. the VCN 1506 of FIG. 15) and a secure host subnet 1608 (e.g. the secure host subnet 1508 of FIG. 15). The VCN 1606 can include a local peering gateway (LPG) 1610 (e.g. the LPG 1510 of FIG. 15) that can be communicatively coupled to a secure shell (SSH) VCN 1612 (e.g. the SSH VCN 1512 of FIG. 15) via an LPG 1510 contained in the SSH VCN 1612. The SSH VCN 1612 can include an SSH subnet 1614 (e.g. the SSH subnet 1514 of FIG. 15), and the SSH VCN 1612 can be communicatively coupled to a control plane VCN 1616 (e.g. the control plane VCN 1516 of FIG. 15) via an LPG 1610 contained in the control plane VCN 1616. The control plane VCN 1616 can be contained in a service tenancy 1619 (e.g. the service tenancy 1519 of FIG. 15), and the data plane VCN 1618 (e.g. the data plane VCN 1518 of FIG. 15) can be contained in a customer tenancy 1621 that may be owned or operated by users, or customers, of the system.

The control plane VCN 1616 can include a control plane DMZ tier 1620 (e.g. the control plane DMZ tier 1520 of FIG. 15) that can include LB subnet(s) 1622 (e.g. LB subnet(s) 1522 of FIG. 15), a control plane app tier 1624 (e.g. the control plane app tier 1524 of FIG. 15) that can include app subnet(s) 1626 (e.g. app subnet(s) 1526 of FIG. 15), a control plane data tier 1628 (e.g. the control plane data tier 1528 of FIG. 15) that can include database (DB) subnet(s) 1630 (e.g. similar to DB subnet(s) 1530 of FIG. 15). The LB subnet(s) 1622 contained in the control plane DMZ tier 1620 can be communicatively coupled to the app subnet(s) 1626 contained in the control plane app tier 1624 and an Internet gateway 1634 (e.g. the Internet gateway 1534 of FIG. 15) that can be contained in the control plane VCN 1616, and the app subnet(s) 1626 can be communicatively coupled to the DB subnet(s) 1630 contained in the control plane data tier 1628 and a service gateway 1636 (e.g. the service gateway of FIG. 15) and a network address translation (NAT) gateway 1638 (e.g. the NAT gateway 1538 of FIG. 15). The control plane VCN 1616 can include the service gateway 1636 and the NAT gateway 1638.

The control plane VCN 1616 can include a data plane mirror app tier 1640 (e.g. the data plane mirror app tier 1540 of FIG. 15) that can include app subnet(s) 1626. The app subnet(s) 1626 contained in the data plane mirror app tier 1640 can include a virtual network interface controller (VNIC) 1642 (e.g. the VNIC of 1542) that can execute a compute instance 1644 (e.g. similar to the compute instance 1544 of FIG. 15). The compute instance 1644 can facilitate communication between the app subnet(s) 1626 of the data plane mirror app tier 1640 and the app subnet(s) 1626 that can be contained in a data plane app tier 1646 (e.g. the data plane app tier 1546 of FIG. 15) via the VNIC 1642 contained in the data plane mirror app tier 1640 and the VNIC 1642 contained in the data plane app tier 1646.

The Internet gateway 1634 contained in the control plane VCN 1616 can be communicatively coupled to a metadata management service 1652 (e.g. the metadata management service 1552 of FIG. 15) that can be communicatively coupled to public Internet 1654 (e.g. public Internet 1554 of FIG. 15). Public Internet 1654 can be communicatively coupled to the NAT gateway 1638 contained in the control plane VCN 1616. The service gateway 1636 contained in the control plane VCN 1616 can be communicatively couple to cloud services 1656 (e.g. cloud services 1556 of FIG. 15).

In some examples, the data plane VCN 1618 can be contained in the customer tenancy 1621. In this case, the IaaS provider may provide the control plane VCN 1616 for each customer, and the IaaS provider may, for each customer, set up a unique compute instance 1644 that is contained in the service tenancy 1619. Each compute instance 1644 may allow communication between the control plane VCN 1616, contained in the service tenancy 1619, and the data plane VCN 1618 that is contained in the customer tenancy 1621. The compute instance 1644 may allow resources, that are provisioned in the control plane VCN 1616 that is contained in the service tenancy 1619, to be deployed or otherwise used in the data plane VCN 1618 that is contained in the customer tenancy 1621.

In other examples, the customer of the IaaS provider may have databases that live in the customer tenancy 1621. In this example, the control plane VCN 1616 can include the data plane mirror app tier 1640 that can include app subnet(s) 1626. The data plane mirror app tier 1640 can reside in the data plane VCN 1618, but the data plane mirror app tier 1640 may not live in the data plane VCN 1618. That is, the data plane mirror app tier 1640 may have access to the customer tenancy 1621, but the data plane mirror app tier 1640 may not exist in the data plane VCN 1618 or be owned or operated by the customer of the IaaS provider. The data plane mirror app tier 1640 may be configured to make calls to the data plane VCN 1618 but may not be configured to make calls to any entity contained in the control plane VCN 1616. The customer may desire to deploy or otherwise use resources in the data plane VCN 1618 that are provisioned in the control plane VCN 1616, and the data plane mirror app tier 1640 can facilitate the desired deployment, or other usage of resources, of the customer.

In some embodiments, the customer of the IaaS provider can apply filters to the data plane VCN 1618. In this embodiment, the customer can determine what the data plane VCN 1618 can access, and the customer may restrict access to public Internet 1654 from the data plane VCN 1618. The IaaS provider may not be able to apply filters or otherwise control access of the data plane VCN 1618 to any outside networks or databases. Applying filters and controls by the customer onto the data plane VCN 1618, contained in the customer tenancy 1621, can help isolate the data plane VCN 1618 from other customers and from public Internet 1654.

In some embodiments, cloud services 1656 can be called by the service gateway 1636 to access services that may not exist on public Internet 1654, on the control plane VCN 1616, or on the data plane VCN 1618. The connection between cloud services 1656 and the control plane VCN 1616 or the data plane VCN 1618 may not be live or continuous. Cloud services 1656 may exist on a different network owned or operated by the IaaS provider. Cloud services 1656 may be configured to receive calls from the service gateway 1636 and may be configured to not receive calls from public Internet 1654. Some cloud services 1656 may be isolated from other cloud services 1656, and the control plane VCN 1616 may be isolated from cloud services 1656 that may not be in the same region as the control plane VCN 1616. For example, the control plane VCN 1616 may be located in “Region 1,” and cloud service “Deployment 15,” may be located in Region 1 and in “Region 2.” If a call to Deployment 15 is made by the service gateway 1636 contained in the control plane VCN 1616 located in Region 1, the call may be transmitted to Deployment 15 in Region 1. In this example, the control plane VCN 1616, or Deployment 15 in Region 1, may not be communicatively coupled to, or otherwise in communication with, Deployment 15 in Region 2.

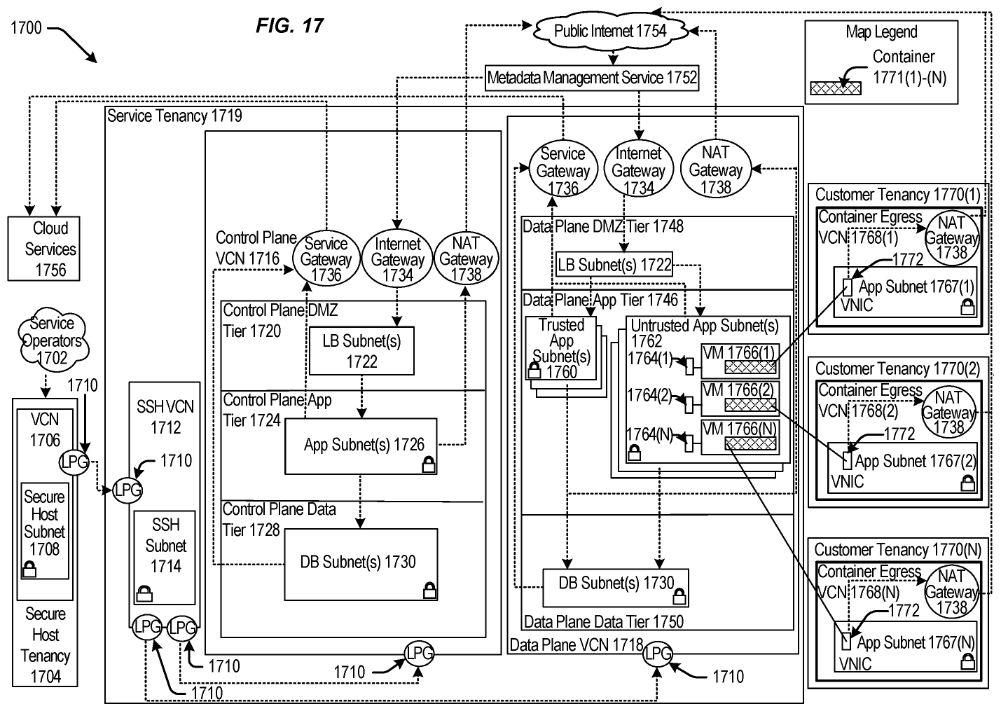

FIG. 17 is a block diagram 1700 illustrating another example pattern of an IaaS architecture, according to at least one embodiment. Service operators 1702 (e.g. service operators 1502 of FIG. 15) can be communicatively coupled to a secure host tenancy 1704 (e.g. the secure host tenancy 1504 of FIG. 15) that can include a virtual cloud network (VCN) 1706 (e.g. the VCN 1506 of FIG. 15) and a secure host subnet 1708 (e.g. the secure host subnet 1508 of FIG. 15). The VCN 1706 can include an LPG 1710 (e.g. the LPG 1510 of FIG. 15) that can be communicatively coupled to an SSH VCN 1712 (e.g. the SSH VCN 1512 of FIG. 15) via an LPG 1710 contained in the SSH VCN 1712. The SSH VCN 1712 can include an SSH subnet 1714 (e.g. the SSH subnet 1514 of FIG. 15), and the SSH VCN 1712 can be communicatively coupled to a control plane VCN 1716 (e.g. the control plane VCN 1516 of FIG. 15) via an LPG 1710 contained in the control plane VCN 1716 and to a data plane VCN 1718 (e.g. the data plane 1518 of FIG. 15) via an LPG 1710 contained in the data plane VCN 1718. The control plane VCN 1716 and the data plane VCN 1718 can be contained in a service tenancy 1719 (e.g. the service tenancy 1519 of FIG. 15).

The control plane VCN 1716 can include a control plane DMZ tier 1720 (e.g. the control plane DMZ tier 1520 of FIG. 15) that can include load balancer (LB) subnet(s) 1722 (e.g. LB subnet(s) 1522 of FIG. 15), a control plane app tier 1724 (e.g. the control plane app tier 1524 of FIG. 15) that can include app subnet(s) 1726 (e.g. similar to app subnet(s) 1526 of FIG. 15), a control plane data tier 1728 (e.g. the control plane data tier 1528 of FIG. 15) that can include DB subnet(s) 1730. The LB subnet(s) 1722 contained in the control plane DMZ tier 1720 can be communicatively coupled to the app subnet(s) 1726 contained in the control plane app tier 1724 and to an Internet gateway 1734 (e.g. the Internet gateway 1534 of FIG. 15) that can be contained in the control plane VCN 1716, and the app subnet(s) 1726 can be communicatively coupled to the DB subnet(s) 1730 contained in the control plane data tier 1728 and to a service gateway 1736 (e.g. the service gateway of FIG. 15) and a network address translation (NAT) gateway 1738 (e.g. the NAT gateway 1538 of FIG. 15). The control plane VCN 1716 can include the service gateway 1736 and the NAT gateway 1738.

The data plane VCN 1718 can include a data plane app tier 1746 (e.g. the data plane app tier 1546 of FIG. 15), a data plane DMZ tier 1748 (e.g. the data plane DMZ tier 1548 of FIG. 15), and a data plane data tier 1750 (e.g. the data plane data tier 1550 of FIG. 15). The data plane DMZ tier 1748 can include LB subnet(s) 1722 that can be communicatively coupled to trusted app subnet(s) 1760 and untrusted app subnet(s) 1762 of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include one or more primary VNICs 1764(1)-(N) that can be communicatively coupled to tenant virtual machines (VMs) 1766(1)-(N). Each tenant VM 1766(1)-(N) can be communicatively coupled to a respective app subnet 1767(1)-(N) that can be contained in respective container egress VCNs 1768(1)-(N) that can be contained in respective customer tenancies 1770(1)-(N). Respective secondary VNICs 1772(1)-(N) can facilitate communication between the untrusted app subnet(s) 1762 contained in the data plane VCN 1718 and the app subnet contained in the container egress VCNs 1768(1)-(N). Each container egress VCNs 1768(1)-(N) can include a NAT gateway 1738 that can be communicatively coupled to public Internet 1754 (e.g. public Internet 1554 of FIG. 15).

The Internet gateway 1734 contained in the control plane VCN 1716 and contained in the data plane VCN 1718 can be communicatively coupled to a metadata management service 1752 (e.g. the metadata management system 1552 of FIG. 15) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively couple to cloud services 1756.

In some embodiments, the data plane VCN 1718 can be integrated with customer tenancies 1770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1746. Code to run the function may be executed in the VMs 1766(1)-(N), and the code may not be configured to run anywhere else on the data plane VCN 1718. Each VM 1766(1)-(N) may be connected to one customer tenancy 1770. Respective containers 1771(1)-(N) contained in the VMs 1766(1)-(N) may be configured to run the code. In this case, there can be a dual isolation (e.g., the containers 1771(1)-(N) running code, where the containers 1771(1)-(N) may be contained in at least the VM 1766(1)-(N) that are contained in the untrusted app subnet(s) 1762), which may help prevent incorrect or otherwise undesirable code from damaging the network of the IaaS provider or from damaging a network of a different customer. The containers 1771(1)-(N) may be communicatively coupled to the customer tenancy 1770 and may be configured to transmit or receive data from the customer tenancy 1770. The containers 1771(1)-(N) may not be configured to transmit or receive data from any other entity in the data plane VCN 1718. Upon completion of running the code, the IaaS provider may kill or otherwise dispose of the containers 1771(1)-(N).

In some embodiments, the trusted app subnet(s) 1760 may run code that may be owned or operated by the IaaS provider. In this embodiment, the trusted app subnet(s) 1760 may be communicatively coupled to the DB subnet(s) 1730 and be configured to execute CRUD operations in the DB subnet(s) 1730. The untrusted app subnet(s) 1762 may be communicatively coupled to the DB subnet(s) 1730, but in this embodiment, the untrusted app subnet(s) may be configured to execute read operations in the DB subnet(s) 1730. The containers 1771(1)-(N) that can be contained in the VM 1766(1)-(N) of each customer and that may run code from the customer may not be communicatively coupled with the DB subnet(s) 1730.

In other embodiments, the control plane VCN 1716 and the data plane VCN 1718 may not be directly communicatively coupled. In this embodiment, there may be no direct communication between the control plane VCN 1716 and the data plane VCN 1718. However, communication can occur indirectly through at least one method. An LPG 1710 may be established by the IaaS provider that can facilitate communication between the control plane VCN 1716 and the data plane VCN 1718. In another example, the control plane VCN 1716 or the data plane VCN 1718 can make a call to cloud services 1756 via the service gateway 1736. For example, a call to cloud services 1756 from the control plane VCN 1716 can include a request for a service that can communicate with the data plane VCN 1718.

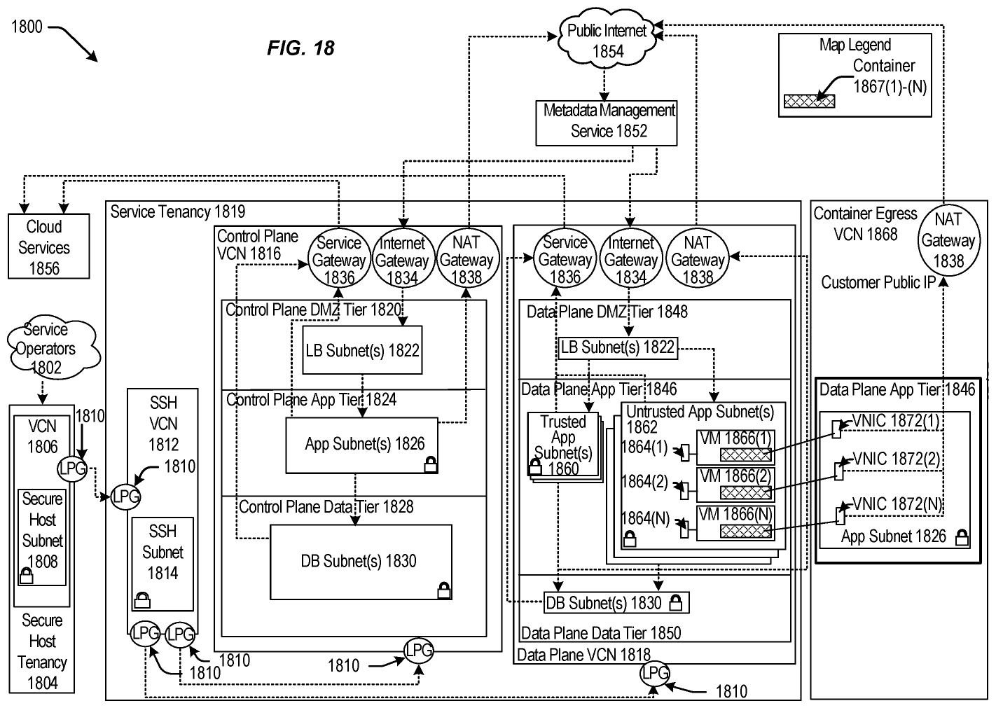

FIG. 18 is a block diagram 1800 illustrating another example pattern of an IaaS architecture, according to at least one embodiment. Service operators 1802 (e.g. service operators 1502 of FIG. 15) can be communicatively coupled to a secure host tenancy 1804 (e.g. the secure host tenancy 1504 of FIG. 15) that can include a virtual cloud network (VCN) 1806 (e.g. the VCN 1506 of FIG. 15) and a secure host subnet 1808 (e.g. the secure host subnet 1508 of FIG. 15). The VCN 1806 can include an LPG 1810 (e.g. the LPG 1510 of FIG. 15) that can be communicatively coupled to an SSH VCN 1812 (e.g. the SSH VCN 1512 of FIG. 15) via an LPG 1810 contained in the SSH VCN 1812. The SSH VCN 1812 can include an SSH subnet 1814 (e.g. the SSH subnet 1514 of FIG. 15), and the SSH VCN 1812 can be communicatively coupled to a control plane VCN 1816 (e.g. the control plane VCN 1516 of FIG. 15) via an LPG 1810 contained in the control plane VCN 1816 and to a data plane VCN 1818 (e.g. the data plane 1518 of FIG. 15) via an LPG 1810 contained in the data plane VCN 1818. The control plane VCN 1816 and the data plane VCN 1818 can be contained in a service tenancy 1819 (e.g. the service tenancy 1519 of FIG. 15).

The control plane VCN 1816 can include a control plane DMZ tier 1820 (e.g. the control plane DMZ tier 1520 of FIG. 15) that can include LB subnet(s) 1822 (e.g. LB subnet(s) 1522 of FIG. 15), a control plane app tier 1824 (e.g. the control plane app tier 1524 of FIG. 15) that can include app subnet(s) 1826 (e.g. app subnet(s) 1526 of FIG. 15), a control plane data tier 1828 (e.g. the control plane data tier 1528 of FIG. 15) that can include DB subnet(s) 1830 (e.g. DB subnet(s) 1730 of FIG. 17). The LB subnet(s) 1822 contained in the control plane DMZ tier 1820 can be communicatively coupled to the app subnet(s) 1826 contained in the control plane app tier 1824 and to an Internet gateway 1834 (e.g. the Internet gateway 1534 of FIG. 15) that can be contained in the control plane VCN 1816, and the app subnet(s) 1826 can be communicatively coupled to the DB subnet(s) 1830 contained in the control plane data tier 1828 and to a service gateway 1836 (e.g. the service gateway of FIG. 15) and a network address translation (NAT) gateway 1838 (e.g. the NAT gateway 1538 of FIG. 15). The control plane VCN 1816 can include the service gateway 1836 and the NAT gateway 1838.

The data plane VCN 1818 can include a data plane app tier 1846 (e.g. the data plane app tier 1546 of FIG. 15), a data plane DMZ tier 1848 (e.g. the data plane DMZ tier 1548 of FIG. 15), and a data plane data tier 1850 (e.g. the data plane data tier 1550 of FIG. 15). The data plane DMZ tier 1848 can include LB subnet(s) 1822 that can be communicatively coupled to trusted app subnet(s) 1860 (e.g. trusted app subnet(s) 1760 of FIG. 17) and untrusted app subnet(s) 1862 (e.g. untrusted app subnet(s) 1762 of FIG. 17) of the data plane app tier 1846 and the Internet gateway 1834 contained in the data plane VCN 1818. The trusted app subnet(s) 1860 can be communicatively coupled to the service gateway 1836 contained in the data plane VCN 1818, the NAT gateway 1838 contained in the data plane VCN 1818, and DB subnet(s) 1830 contained in the data plane data tier 1850. The untrusted app subnet(s) 1862 can be communicatively coupled to the service gateway 1836 contained in the data plane VCN 1818 and DB subnet(s) 1830 contained in the data plane data tier 1850. The data plane data tier 1850 can include DB subnet(s) 1830 that can be communicatively coupled to the service gateway 1836 contained in the data plane VCN 1818.

The untrusted app subnet(s) 1862 can include primary VNICs 1864(1)-(N) that can be communicatively coupled to tenant virtual machines (VMs) 1866(1)-(N) residing within the untrusted app subnet(s) 1862. Each tenant VM 1866(1)-(N) can run code in a respective container 1867(1)-(N), and be communicatively coupled to an app subnet 1826 that can be contained in a data plane app tier 1846 that can be contained in a container egress VCN 1868. Respective secondary VNICs 1872(1)-(N) can facilitate communication between the untrusted app subnet(s) 1862 contained in the data plane VCN 1818 and the app subnet contained in the container egress VCN 1868. The container egress VCN can include a NAT gateway 1838 that can be communicatively coupled to public Internet 1854 (e.g. public Internet 1554 of FIG. 15).

The Internet gateway 1834 contained in the control plane VCN 1816 and contained in the data plane VCN 1818 can be communicatively coupled to a metadata management service 1852 (e.g. the metadata management system 1552 of FIG. 15) that can be communicatively coupled to public Internet 1854. Public Internet 1854 can be communicatively coupled to the NAT gateway 1838 contained in the control plane VCN 1816 and contained in the data plane VCN 1818. The service gateway 1836 contained in the control plane VCN 1816 and contained in the data plane VCN 1818 can be communicatively couple to cloud services 1856.

In some examples, the pattern illustrated by the architecture of block diagram 1800 of FIG. 18 may be considered an exception to the pattern illustrated by the architecture of block diagram 1700 of FIG. 17 and may be desirable for a customer of the IaaS provider if the IaaS provider cannot directly communicate with the customer (e.g., a disconnected region). The respective containers 1867(1)-(N) that are contained in the VMs 1866(1)-(N) for each customer can be accessed in real-time by the customer. The containers 1867(1)-(N) may be configured to make calls to respective secondary VNICs 1872(1)-(N) contained in app subnet(s) 1826 of the data plane app tier 1846 that can be contained in the container egress VCN 1868. The secondary VNICs 1872(1)-(N) can transmit the calls to the NAT gateway 1838 that may transmit the calls to public Internet 1854. In this example, the containers 1867(1)-(N) that can be accessed in real-time by the customer can be isolated from the control plane VCN 1816 and can be isolated from other entities contained in the data plane VCN 1818. The containers 1867(1)-(N) may also be isolated from resources from other customers.

In other examples, the customer can use the containers 1867(1)-(N) to call cloud services 1856. In this example, the customer may run code in the containers 1867(1)-(N) that requests a service from cloud services 1856. The containers 1867(1)-(N) can transmit this request to the secondary VNICs 1872(1)-(N) that can transmit the request to the NAT gateway that can transmit the request to public Internet 1854. Public Internet 1854 can transmit the request to LB subnet(s) 1822 contained in the control plane VCN 1816 via the Internet gateway 1834. In response to determining the request is valid, the LB subnet(s) can transmit the request to app subnet(s) 1826 that can transmit the request to cloud services 1856 via the service gateway 1836.

It should be appreciated that IaaS architectures 1500, 1600, 1700, 1800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 19 illustrates an example computer system 1900, in which various embodiments may be implemented. The system 1900 may be used to implement any of the computer systems described above. As shown in the figure, computer system 1900 includes a processing unit 1904 that communicates with a number of peripheral subsystems via a bus subsystem 1902. These peripheral subsystems may include a processing acceleration unit 1906, an I/O subsystem 1908, a storage subsystem 1918 and a communications subsystem 1924. Storage subsystem 1918 includes tangible computer-readable storage media 1922 and a system memory 1910.

Bus subsystem 1902 provides a mechanism for letting the various components and subsystems of computer system 1900 communicate with each other as intended. Although bus subsystem 1902 is shown schematically as a single bus, alternative embodiments of the bus subsystem may utilize multiple buses. Bus subsystem 1902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1904, which can be implemented as one or more integrated circuits (e.g., a conventional microprocessor or microcontroller), controls the operation of computer system 1900. One or more processors may be included in processing unit 1904. These processors may include single core or multicore processors. In certain embodiments, processing unit 1904 may be implemented as one or more independent processing units 1932 and/or 1934 with single or multicore processors included in each processing unit. In other embodiments, processing unit 1904 may also be implemented as a quad-core processing unit formed by integrating two dual-core processors into a single chip.

In various embodiments, processing unit 1904 can execute a variety of programs in response to program code and can maintain multiple concurrently executing programs or processes. At any given time, some or all of the program code to be executed can be resident in processor(s) 1904 and/or in storage subsystem 1918. Through suitable programming, processor(s) 1904 can provide various functionalities described above. Computer system 1900 may additionally include a processing acceleration unit 1906, which can include a digital signal processor (DSP), a special-purpose processor, and/or the like.

I/O subsystem 1908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1900 may comprise a storage subsystem 1918 that comprises software elements, shown as being currently located within a system memory 1910. System memory 1910 may store program instructions that are loadable and executable on processing unit 1904, as well as data generated during the execution of these programs.

Depending on the configuration and type of computer system 1900, system memory 1910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1904. In some implementations, system memory 1910 may include multiple different types of memory, such as static random access memory (SRAM) or dynamic random access memory (DRAM). In some implementations, a basic input/output system (BIOS), containing the basic routines that help to transfer information between elements within computer system 1900, such as during start-up, may typically be stored in the ROM. By way of example, and not limitation, system memory 1910 also illustrates application programs 1912, which may include client applications, Web browsers, mid-tier applications, relational database management systems (RDBMS), etc., program data 1914, and an operating system 1916. By way of example, operating system 1916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 19 OS, and Palm® OS operating systems.

Storage subsystem 1918 may also provide a tangible computer-readable storage medium for storing the basic programming and data constructs that provide the functionality of some embodiments. Software (programs, code modules, instructions) that when executed by a processor provide the functionality described above may be stored in storage subsystem 1918. These software modules or instructions may be executed by processing unit 1904. Storage subsystem 1918 may also provide a repository for storing data used in accordance with the present disclosure.

Storage subsystem 1900 may also include a computer-readable storage media reader 1920 that can further be connected to computer-readable storage media 1922. Together and, optionally, in combination with system memory 1910, computer-readable storage media 1922 may comprehensively represent remote, local, fixed, and/or removable storage devices plus storage media for temporarily and/or more permanently containing, storing, transmitting, and retrieving computer-readable information.

Computer-readable storage media 1922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1900.

By way of example, computer-readable storage media 1922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1922 may include, but is not limited to, Zip® drives, flash memory cards, universal serial bus (USB) flash drives, secure digital (SD) cards, DVD disks, digital video tape, and the like. Computer-readable storage media 1922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1900.

Communications subsystem 1924 provides an interface to other computer systems and networks. Communications subsystem 1924 serves as an interface for receiving data from and transmitting data to other systems from computer system 1900. For example, communications subsystem 1924 may enable computer system 1900 to connect to one or more devices via the Internet. In some embodiments communications subsystem 1924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1924 can provide wired network connectivity (e.g., Ethernet) in addition to or instead of a wireless interface.

In some embodiments, communications subsystem 1924 may also receive input communication in the form of structured and/or unstructured data feeds 1926, event streams 1928, event updates 1930, and the like on behalf of one or more users who may use computer system 1900.

By way of example, communications subsystem 1924 may be configured to receive data feeds 1926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1924 may also be configured to receive data in the form of continuous data streams, which may include event streams 1928 of real-time events and/or event updates 1930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1924 may also be configured to output the structured and/or unstructured data feeds 1926, event streams 1928, event updates 1930, and the like to one or more databases that may be in communication with one or more streaming data source computers coupled to computer system 1900.

Computer system 1900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
receiving, by an accelerator of a smart network interface card (smartNIC), a first instruction, the first instruction instructing the accelerator to register a pairing between the accelerator and a remote programming data plane of a device that is physically distinct from the smart network interface card and is communicatively connected to the smart network interface card via a network path;
storing, by the accelerator, registration data indicating the pairing between the accelerator and the remote programming data plane of the device;
receiving, by the accelerator from the remote programming data plane, a second instruction over the network path, the second instruction associated with processing one or more flows; and
processing, by the accelerator, instruction data corresponding to the second instruction based at least in part on determining that the second instruction was received from the remote programming data plane of the device over the network path.

2. The computer-implemented method of claim 1, wherein the pairing indicates that the accelerator is configured to perform at least one of: (I) accepting subsequent programming instructions from the remote programming data plane to program the accelerator, (II) rejecting subsequent programming instructions from other devices to program the accelerator, or (III) forwarding at least a portion of packets received by the accelerator to the remote programming data plane.

3. The computer-implemented method of claim 1, wherein the second instruction is included within a single control packet, the single control packet having characteristics corresponding to at least one of: (I) being formatted according to an Internet Protocol (IP) header, a source address of the header identifying the remote programming data plane, (II) having a payload that fits within a jumbo frame, or (III) including the second instruction within a predefined data structure of the payload of the single control packet.

4. The computer-implemented method of claim 1, wherein processing the instruction data further comprises storing the instruction data as programming instructions, the method further comprising:
receiving, by the accelerator, a data packet; and
forwarding, by the accelerator, the data packet to the remote programming data plane via the network path based at least in part on the stored programming instructions.

5. The computer-implemented method of claim 1, wherein the first instruction is encrypted within an encrypted packet using a cryptographic key and transmitted to the smart network interface card via the network path.

6. The computer-implemented method of claim 5, wherein the first instruction is received from: (I) a local programming data plane that is local to the smart network interface card, or (II) a second device that is remote to the smart network interface card.

7. A smart network interface card (smartNIC), comprising:
an accelerator comprising a set of one or more processors of a plurality of processors; and
a memory comprising computer-executable instructions that, when executed by one or more of the plurality of processors, cause the smart network interface card to:
receive, by an accelerator of a smart network interface card (smartNIC), a first instruction, the first instruction instructing the accelerator to register a pairing between the accelerator and a remote programming data plane of a device that is physically distinct from the smart network interface card and is communicatively connected to the smart network interface card via a network path;
store, by the accelerator, registration data indicating the pairing between the accelerator and the remote programming data plane of the device;
receive, by the accelerator from the remote programming data plane, a second instruction over the network path, the second instruction associated with processing one or more flows; and
process, by the accelerator, instruction data corresponding to the second instruction based at least in part on determining that the second instruction was received from the remote programming data plane of the device over the network path.

8. The smart network interface card of claim 7, wherein the memory comprises further computer-executable instructions that, when executed by the one or more of the plurality of processors, further cause the smart network interface card to:
determine, by the accelerator, that a second pairing between the accelerator and a second remote programming data plane of a second device is defective based at least in part on determining that the second device is unreachable via the network path, and wherein the device corresponds to an alternative device for pairing the remote programming data plane with the accelerator in an event when the second device is unreachable.

9. The smart network interface card of claim 7, further comprising:
a programming data plane comprising a second set of one or more processors of the plurality of processors, wherein the memory comprises further computer-executable instructions that, when executed by the one or more of the plurality of processors, further cause the smart network interface card to:
receive, by the accelerator, a second instruction to register a new pairing between the accelerator and the programming data plane; and
store, by the accelerator, second registration data indicating the new pairing between the accelerator and the programming data plane.

10. The smart network interface card of claim 7, wherein the memory comprises further computer-executable instructions that, when executed by the one or more of the plurality of processors, further cause the smart network interface card to:
receive, by the accelerator, a third instruction from a second remote programming data plane of a second device via the network path; and
reject, by the accelerator, the third instruction based at least in part on the stored registration data indicating the pairing with the remote programming data plane of the device.

11. The smart network interface card of claim 7, wherein the memory comprises further computer-executable instructions that, when executed by the one or more of the plurality of processors, further cause the smart network interface card to:
receive, by the accelerator, a data packet; and
determine, by the accelerator, that the data packet should be forwarded to another device based at least in part on the processed instruction data.

12. The smart network interface card of claim 7, wherein the second instruction is included within a single control packet that is encrypted, and wherein the memory comprises further computer-executable instructions that, when executed by the one or more of the plurality of processors, further cause the smart network interface card to:
retrieve, by the accelerator, a cryptographic key that is associated with the remote programming data plane and operable for decrypting the single control packet; and
validate, by the accelerator, that the single control packet is associated with a currently paired remote programming data plane based at least in part on decrypting the encrypted single control packet to obtain the second instruction.

13. The smart network interface card of claim 12, wherein processing the instruction data further comprises programming, by the accelerator, the memory with instructions for processing subsequent packets received by the accelerator that are associated with the one or more flows.

14. The smart network interface card of claim 7, wherein the memory comprises further computer-executable instructions that, when executed by the one or more of the plurality of processors, further cause the smart network interface card to:
receive, by the accelerator, a data packet;
determine, by the accelerator, that the data packet should be further processed by the remote programming data plane;
transmit, by the accelerator, the data packet to the remote programming data plane via the network path;
receive, by the accelerator, the second instruction via a single control packet, the second instruction including instructions to add a new cache entry to an accelerator cache, the new cache entry associated with a new approved flow; and
forwarding, by the accelerator, the data packet based at least in part on determining that the data packet is associated with the new approved flow.

15. The smart network interface card of claim 7, wherein the memory comprises further computer-executable instructions that, when executed by the one or more of the plurality of processors, further cause the smart network interface card to:
establish, by the accelerator, a Transport Control Protocol (TCP) connection with the remote programming data plane, wherein the second instruction is transmitted by the remote programming data plane to the accelerator via at least one control packet over the Transport Control Protocol connection.

16. One or more non-transitory computer-readable storage media comprising computer-executable instructions that, when executed by one or more processors of a smart network interface card (smartNIC), cause the one or more processors to:
receive, by an accelerator of a smart network interface card (smartNIC), a first instruction, the first instruction instructing the accelerator to register a pairing between the accelerator and a remote programming data plane of a device that is physically distinct from the smart network interface card and is communicatively connected to the smart network interface card via a network path;
store, by the accelerator, registration data indicating the pairing between the accelerator and the remote programming data plane of the device;
receive, by the accelerator from the remote programming data plane, a second instruction over the network path, the second instruction associated with processing one or more flows; and
process, by the accelerator, instruction data corresponding to the second instruction based at least in part on determining that the second instruction was received from the remote programming data plane of the device over the network path.

17. The one or more non-transitory computer-readable storage media of claim 16, wherein the second instruction is received within a single control packet, a payload of the single control packet including programming instructions associated with at least one of: (I) a flow expiry, (II) a newly approved flow, (III) a flow policy, (IV) a security list update, or (V) flow statistics.

18. The one or more non-transitory computer-readable storage media of claim 16, wherein the instructions further comprise:
retrieving, by the accelerator, a flow statistics log; and
transmitting, by the accelerator to the remote programming data plane, the flow statistics log to be used by the remote programming data plane to generate a statistics report.

19. The one or more non-transitory computer-readable storage media of claim 16, wherein the instructions further comprise:
determining, by the accelerator, that the remote programming data plane is unreachable via the network path;
determining, by the accelerator, that a new pairing should be registered with an alternate remote programming data plane of another remote device or a local programming data plane that is local to the smart network interface card; and
storing, by the accelerator, new registration data indicating the new pairing.

20. The one or more non-transitory computer-readable storage media of claim 16, wherein at least one of the first instruction or the second instruction is received via a single control packet, the single control packet including a control packet header that is used by the accelerator to differentiate between a control packet type and a data packet type.
